(19) United States
(12) Patent Application Publication
(10) Pub. No.: US 2026/0172606 A1
(43) Pub. Date: Jun. 18, 2026

(54) METHODS AND DEVICES OF EXTRAPOLATION FILTER-BASED PREDICTION MODE

(71) Applicant: BEIJING DAJIA INTERNET INFORMATION TECHNOLOGY CO., LTD., Beijing (CN)

(72) Inventors: Hong-Jheng JHU, San Diego, CA (US); Che-Wei KUO, San Diego, CA (US); Xiaoyu XIU, San Diego, CA (US); Wei CHEN, San Diego, CA (US); Ning YAN, San Diego, CA (US); Changyue MA, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/536,707

(22) Filed: Feb. 11, 2026

Related U.S. Application Data
(63) Continuation of application No. PCT/US2024/042490, filed on Aug. 15, 2024.
(60) Provisional application No. 63/520,145, filed on Aug. 17, 2023.

(51) Int. Cl. H04N 19/70

(52) U.S. Cl. CPC H04N 19/70

(57) ABSTRACT

A method for video decoding including determining a decoded video block predicted with Extrapolation Filter-based intra Prediction (EIP) mode; obtaining a stored filter shape and stored filter coefficients corresponding to an extrapolation filter of the decoded video block, and predicting the sample values of the current block with EIP mode based on the stored filter shape and the stored filter coefficients.

### CROSS-REFERENCE TO RELATED APPLICATION

This application is a continuation of the PCT application No. PCT/US2024/042490 filed on Aug. 15, 2024 and based upon and claims priority to Provisional Application No. 63/520,145 filed on Aug. 17, 2023. The entire content thereof is incorporated herein by reference in its entirety.

### TECHNICAL FIELD

This application is related to video coding and compression. More specifically, this application relates to methods and devices of extrapolation filter-based prediction mode.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Embodiments of the present disclosure provide methods and devices of extrapolation filter-based prediction mode.

According to one aspect of the present disclosure, there is provided a method for video decoding, comprising: determining a decoded video block predicted with Extrapolation Filter-based intra Prediction (EIP) mode; obtaining a stored filter shape and stored filter coefficients corresponding to an extrapolation filter of the decoded video block; and predicting the sample values of the current block with EIP mode based on the stored filter shape and the stored filter coefficients.

According to one aspect of the present disclosure, there is provided a method for video encoding, comprising: determining an encoded video block predicted with Extrapolation Filter-based intra Prediction (EIP) mode; obtaining a stored filter shape and stored filter coefficients corresponding to an extrapolation filter of the encoded video block; and predicting the sample values of the current block with EIP mode based on the stored filter shape and the stored filter coefficients; and generating a bitstream based at least in part on the predicted sample values of the current block.

According to one aspect of the present disclosure, there is provided a method for video decoding, comprising: dividing a video block into a plurality of sub-partitions; predicting sample values of a first sub-partition of the video block with Extrapolation Filter-based intra Prediction (EIP) mode; reconstructing sample values of the first sub-partition based on the predicted sample values of the first sub-partition; and predicting sample values of a second sub-partition of the video block adjacent to the first sub-partition with EIP mode based at least in part on the reconstructed sample values of the first sub-partition.

According to one aspect of the present disclosure, there is provided a method for video encoding, comprising: dividing a video block into a plurality of sub-partitions; predicting sample values of a first sub-partition of the video block with Extrapolation Filter-based intra Prediction (EIP) mode; reconstructing sample values of the first sub-partition based on the predicted sample values of the first sub-partition; predicting sample values of a second sub-partition of the video block adjacent to the first sub-partition with EIP mode based at least in part on the reconstructed sample values of the first sub-partition; and generating a bitstream based at least in part on the predicted sample values of the second sub-partition.

According to one aspect of the present disclosure, there is provided a method for video decoding, comprising: predicting two or more sets of sample values of a video block with a plurality of prediction modes, wherein at least one of the plurality of the prediction modes comprises Extrapolation Filter-based intra Prediction (EIP) mode; and obtaining a final predicted video block by performing weighting operation based on the two or more sets of sample values of the video block.

According to one aspect of the present disclosure, there is provided a method for video encoding, comprising: predicting two or more sets of sample values of a video block with a plurality of prediction modes, wherein at least one of the plurality of the prediction modes comprises Extrapolation Filter-based intra Prediction (EIP) mode; obtaining a final predicted video block by performing weighting operation based on the two or more sets of sample values of the video block; and generating a bitstream based at least in part on the final predicted video block.

According to one aspect of the present disclosure, there is provided an apparatus, comprising: one or more processors; and one or more storage devices storing computer-executable instructions that, when executed, cause the one or more processors to perform the operations of the method of the present disclosure.

According to one aspect of the present disclosure, there is provided a computer program product, storing computer-executable instructions that, when executed, cause one or more processors to perform the operations of the method of the present disclosure.

According to one aspect of the present disclosure, there is provided a computer readable storage medium storing instructions which when executed by a computing device having one or more processors, cause the one or more processors to perform the method of the present disclosure and store a bitstream to be decoded by the method of the present disclosure, or perform the method of the present disclosure and store a bitstream generated by the method of the present disclosure.

According to one aspect of the present disclosure, there is provided a computer readable medium storing a bitstream, wherein the bitstream is to be decoded by performing the operations of the method of the present disclosure, or the bitstream is obtained by performing the operations of the method of the present disclosure.

According to one aspect of the present disclosure, there is provided a method for receiving a bitstream to be decoded by the method of the present disclosure.

According to one aspect of the present disclosure, there is provided a method for transmitting a bitstream generated by the method of the present disclosure.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A, 4B, 4C, 4D and 4E are block diagrams illustrating how a frame is recursively partitioned into multiple video blocks of different sizes and shapes in accordance with some implementations of the present disclosure.

FIG. 5 illustrates a diagram of intra modes as defined in VVC.

FIG. 6 illustrates a diagram of multiple reference lines for intra prediction.

FIGS. 7A and 7B illustrate diagrams of reference samples for Position-Dependent intra Prediction Combination (PDPC) in a top-right diagonal mode and a bottom-left diagonal mode respectively.

FIG. 8A illustrates a diagram of sub-partitions for 4×8 and 8×4 CUs.

FIG. 8B illustrates a diagram of sub-partitions for CUs other than 4×8, 8×4 and 4×4 CUs.

FIG. 9 illustrates a diagram of locations of left and above samples of a CU involved in a Cross-Component Linear Model (CCLM) prediction.

FIG. 10 illustrates a diagram of a Matrix weighted Intra Prediction (MIP) process.

FIG. 11 illustrates a diagram of spatial part of the convolutional filter.

FIG. 12 illustrates a diagram of reference area (with its paddings) used to derive the filter coefficients.

FIG. 13 illustrates a diagram of four Sobel based gradient patterns for GLM.

FIG. 14 illustrates a diagram of three defined types of reconstructed areas.

FIG. 15 illustrates a diagram of three defined types of filter shapes that each have fifteen inputs and generate one output.

FIG. 16 illustrates an example of generating predictions for different positions in the current block by a diagonal order.

FIG. 17 illustrates examples of prediction for different positions in the current block.

FIG. 18 illustrates a diagram of spatial terms corresponding to neighboring luma samples.

FIG. 19 illustrates a diagram of examples of different shape/number of filter taps.

FIG. 20 illustrates a diagram of examples of different shape/number of filter taps.

FIG. 21 illustrates a diagram of examples of different shape/number of filter taps.

FIG. 22 illustrates a diagram of possible positions of candidate regions.

FIG. 23 illustrates a diagram of possible positions of candidates.

FIG. 24 illustrates a diagram of examples of different shape/number of filter taps.

FIG. 25 illustrates a diagram of examples of different shape/number of filter taps.

FIG. 26 illustrates a workflow of a method for video decoding according to one or more aspects of the present disclosure.

FIG. 27 illustrates a workflow of a method for video encoding according to one or more aspects of the present disclosure.

FIG. 28 illustrates a workflow of a method for video decoding according to one or more aspects of the present disclosure.

FIG. 29 illustrates a workflow of a method for video encoding according to one or more aspects of the present disclosure.

FIG. 30 illustrates a workflow of a method for video decoding according to one or more aspects of the present disclosure.

FIG. 31 illustrates a workflow of a method for video encoding according to one or more aspects of the present disclosure.

FIG. 32 is a diagram illustrating a computing environment coupled with a user interface, according to some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

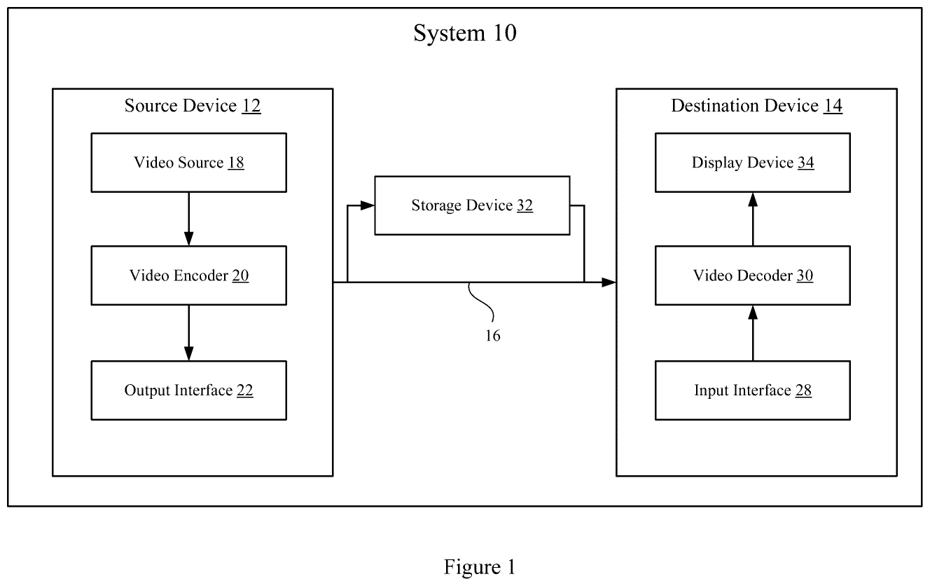

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter. The encoded video data may comprise a sequence of pictures, each of which may comprise one or more sample arrays, for example, luma (Y) only for monochrome; luma and two chroma in YCbCr or YCgCo domain; or green, blue, and red in GBR (also known as RGB) domain. For convenience of notation and terminology in this application, in some embodiments, variables and terms associated with each set of three sample arrays may be referred to as luma and chroma, where the two chroma arrays may be referred to as Cb and Cr, regardless of the actual color representation method in use. The video data may be in a chroma format of 4:0:0, 4:2:0, 4:2:2, or 4:4:4, but the present application is not limited thereto.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

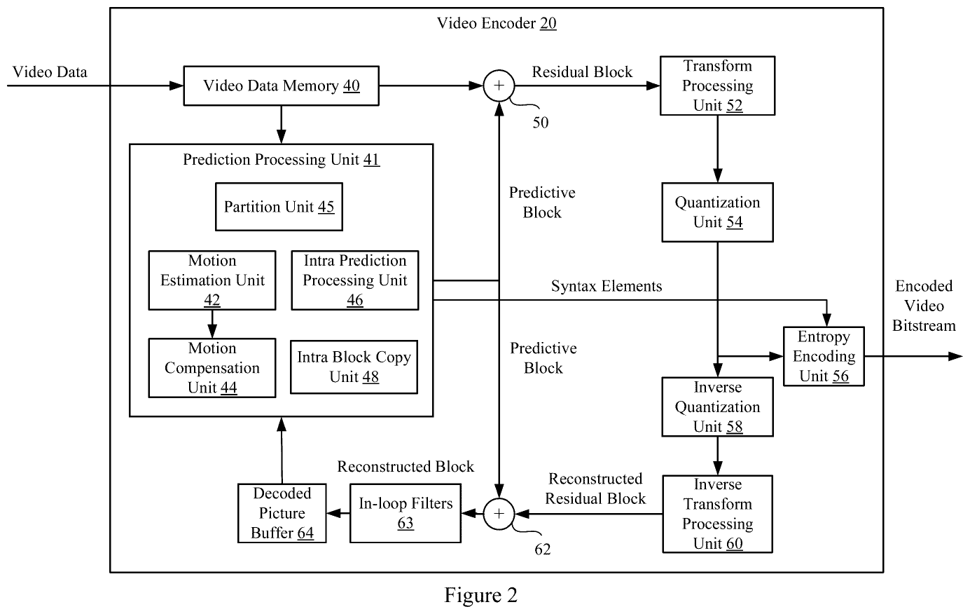

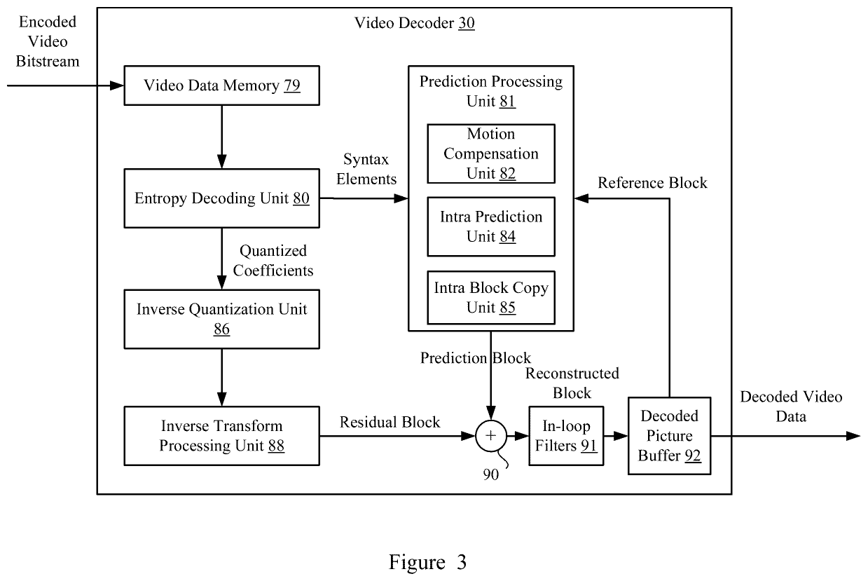

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (Saas), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component and two chroma components (which may represent Y, Cb and Cr in YCbCr domain; Y, Cg and Co in YCgCo domain; or G, B and R in RGB domain for convenience of notation and terminology in this application as described above) according to any other of the luma component and the two chroma components to modify said any component based on the selected offset. Further, it should also be illustrated that a first component mentioned herein may be any of the luma component and the two chroma components, a second component mentioned herein may be any other of the luma component and the two chroma components, and a third component mentioned herein may be a remaining one of the luma component and the two chroma components. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

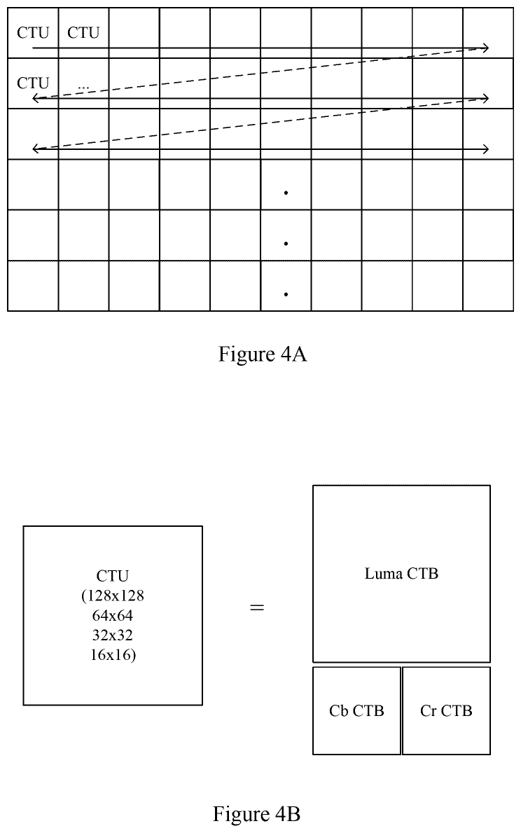

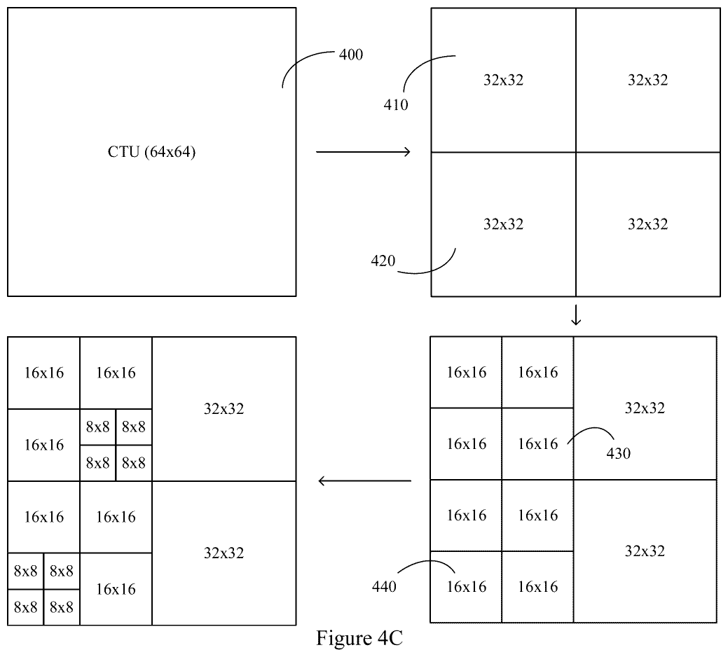

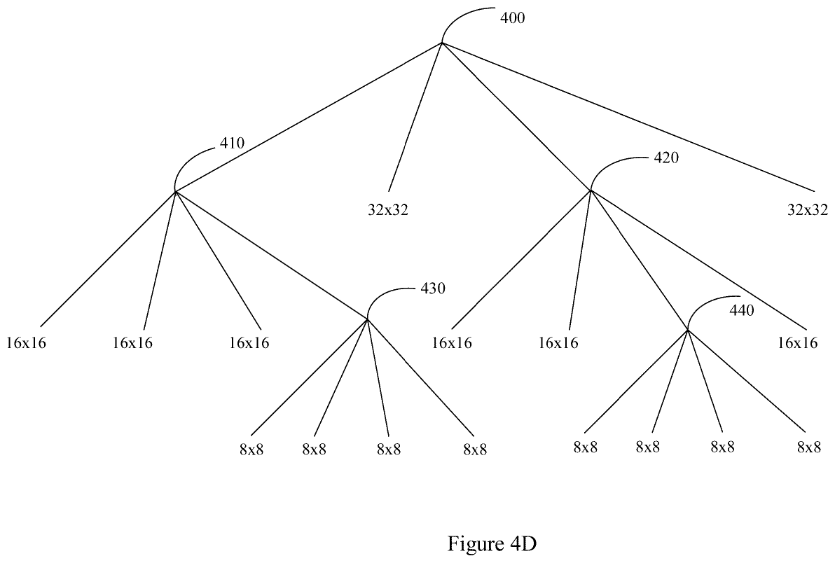

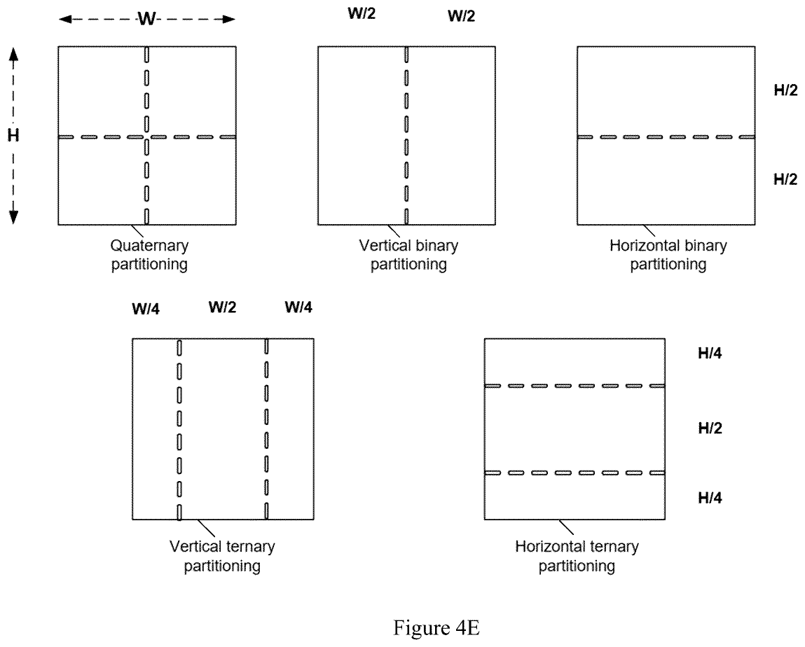

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

In general, the basic intra prediction scheme applied in VVC is almost kept the same as that of HEVC, except that several prediction tools are further extended, added and/or improved, e.g., extended intra prediction with wide-angle intra modes, Multiple Reference Line (MRL) intra prediction, Position-Dependent intra Prediction Combination (PDPC), Intra Sub-Partition (ISP) prediction, Cross-Component Linear Model (CCLM) prediction, and Matrix weighted Intra Prediction (MIP).

Extended Intra Prediction with Wide-Angle Intra Modes

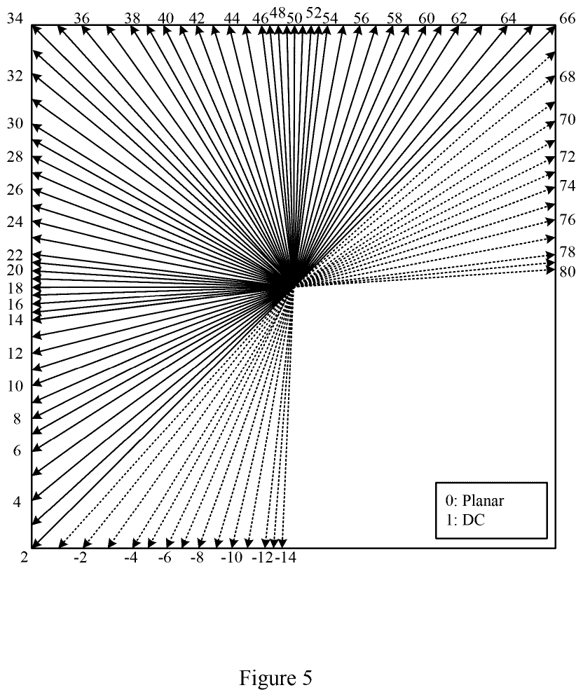

Like HEVC, VVC uses a set of reference samples neighboring a current CU (i.e., above the current CU or left to the current CU) to predict samples of the current CU. However, to capture finer edge directions present in natural video (especially for video content in high resolutions, e.g., 4K), a number of angular intra modes is extended from 33 in HEVC to 93 in VVC. FIG. 5 illustrates a diagram of intra modes as defined in VVC. As shown in FIG. 5, among the 93 angular intra modes, modes 2 to 66 are conventional angular intra modes, and modes −1 to −14 and modes 67 to 80 are wide-angle intra modes. In addition to the angular intra modes, the planar mode (mode 0 in FIG. 5) and Direct Current (DC) mode (mode 1 in FIG. 5) of HEVC are also applied in VVC.

Since a quad/binary/ternary tree partition structure is applied in VVC, besides video blocks in square shape, rectangular video blocks also exist for the intra prediction in VVC. Due to unequal width and height of one given video block, various sets of angular intra modes may be selected from the 93 angular intra modes for different block shapes. More specifically, for both square and rectangular video blocks, besides planar and DC modes, 65 angular intra modes among the 93 angular intra modes are also supported for each block shape. When a rectangular block shape of a video block satisfies a certain condition, an index of a wide-angle intra mode of the video block may be adaptively determined by the video decoder 30 according to an index of a conventional angular intra mode received from the video encoder 20 using a mapping relationship as shown in Table 1 below. That is, for non-square blocks, the wide-angle intra modes are signaled by the video encoder 20 using the indexes of the conventional angular intra modes, which are mapped to indexes of the wide-angle intra modes by the video decoder 30 after being parsed, thus ensuring that a total number (i.e., 67) of intra modes (i.e., the planar mode, the DC mode and 65 angular intra modes among the 93 angular intra modes) is unchanged, and the intra mode coding method is unchanged. As a result, a good efficiency of signaling intra modes is achieved while providing a consistent design across different block sizes.

Table 1 shows a mapping relationship between indexes of conventional angular intra modes and indexes of wide-angle intra modes for the intra prediction of different block shapes in VCC, wherein W represents a width of a video block, and H represents a height of the video block.

TABLE 1

| | | Indexes of conventional angular | Indexes of wide-angle intra |
|---|---|---|---|
| Block shape | Aspect ratio | intra modes | modes |
| Square, | W/H == 1 | None | None |
| W = H | | | |
| Flat | W/H == 2 | 2, 3, 4, 5, 6, 7, 8, 9 | 67, 68, 69, 70, 71, 72, 73, 74 |
| rectangle, | W/H == 4 | 2, 3, 4, 5, 6, 7, 8, 9, 10, 11 | 67, 68, 69, 70, 71, 72, 73, 74, |
| W > H | | | 75, 76 |
| | W/H == 8 | 2, 3, 4, 5, 6, 7, 8, 9, 10, 11, 12, 13 | 67, 68, 69, 70, 71, 72, 73, 74, |
| | | | 75, 76, 77, 78 |
| | W/H == 16 | 2, 3, 4, 5, 6, 7, 8, 9, 10, 11, 12, 13, | 67, 68, 69, 70, 71, 72, 73, 74, |
| | | 14, 15 | 75, 76, 77, 78, 79, 80 |
| Tall | W/H == ½ | 59, 60, 61, 62, 63, 64, 65, 66 | −8, −7, −6, −5, −4, −3, −2, −1 |
| rectangle, | W/H == ¼ | 57, 58, 59, 60, 61, 62, 63, 64, 65, 66 | −10, −9, −8, −7, −6, −5, −4, −3, −2, |
| W < H | | | −1 |
| | W/H == ⅛ | 55, 56, 57, 58, 59, 60, 61, 62, 63, | −12, −11, −10, −9, −8, −7, −6, −5, |
| | | 64, 65, 66 | −4, −3, −2, −1 |
| | W/H == 1/16 | 53, 54, 55, 56, 57, 58, 59, 60, 61, | −14, −13, −12, −11, −10, −9, −8, |
| | | 62, 63, 64, 65, 66 | −7, −6, −5, −4, −3, −2, −1 |

### MRL Intra Prediction

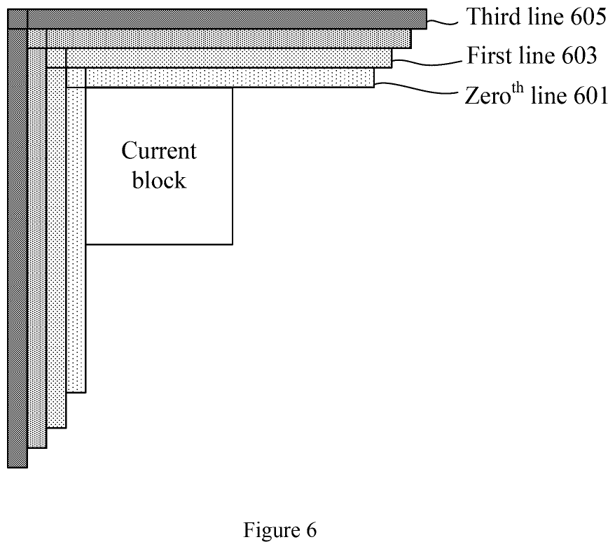

Similarly to the intra prediction in HEVC, all the intra modes (i.e., planar, DC and angular intra modes) in VVC utilize a set of reference samples above and left to a current video block for intra prediction. However, differently from HEVC where only the nearest row/column (i.e., a zeroth line 601 in FIG. 6) of reference samples are used, MRL intra prediction is introduced in VVC where in addition to the nearest row/column of reference samples, two additional rows/columns of reference samples (i.e., a first line 603 and a third line 605 in FIG. 6) may be used for the intra prediction. An index of a selected row/column of reference samples is signaled from the video encoder 20 to the video decoder 30. When a non-nearest row/column of reference samples (i.e., the first line 603 or the third line 605 in FIG. 6) is selected, the planar mode is excluded from a set of intra modes that may be used to predict the current video block. The MRL intra prediction is disabled for a first row/column of video blocks inside a current CTU to prevent using extended reference samples outside the current CTU.

### PDPC

As mentioned earlier, the intra prediction samples are generated from a set of neighboring reference samples, which may introduce discontinuities along block boundaries between a current video block and neighboring video blocks thereof. The PDPC tool is introduced in VVC to solve such problems by employing a weighted combination of intra prediction samples with boundary reference samples. In VVC, PDPC may be enabled for the following intra modes without signaling: planar mode, DC mode, angular intra modes with indexes less than or equal to that of a horizontal intra mode (i.e., mode 18), and angular intra modes with indexes greater than or equal to that of a vertical intra mode (i.e., mode 50) and less than or equal to 80. If a Block Differential Pulse Coded Modulation (BDPCM) mode is applied for the current block or an index of a selected row/column of reference samples for MRL intra prediction is greater than 0, PDPC is not applied. Assuming that a prediction sample of a current sample located at coordinate (x, y) is pred(x,y), a modified prediction sample pred′(x,y) after the PDPC is performed is calculated as:

$${pred}^{′} ( x , y ) = Clip 3 ( 0 , ( 1 << BitDepth ) - 1 , ( wL \times {R}_{- 1 , {y}^{′}} + wT \times {R}_{{x}^{′} , - 1} + ( 64 - wL - wT ) \times pred ( x , y ) + 32 ) >> 6 ) \qquad ( 1 )$$

where BitDepth represents a bit depth of samples, R_{x′,-1} and R_{-1,y′} represent reference samples located at top and left boundaries of the current sample, respectively, wL and wT are weights which are adaptively selected according to an intra mode and a block size of the current block, “>>” represents a bitwise right shift operation, and “<<” indicates a bitwise left shift operation.

The function Clip3(x, y, z) in the equation (1) may be defined as follows:

$$Clip 3 ( x , y , z ) = \{ \begin{matrix}x & z < x \\ y & z > y \\ z & otherwise\end{matrix} \qquad ( 2 )$$

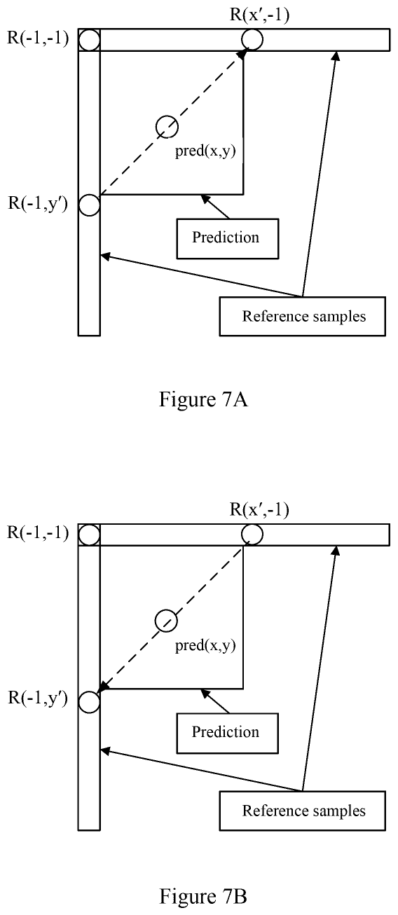

FIG. 7A and FIG. 7B illustrate diagrams of reference samples for PDPC in a top-right diagonal mode and a bottom-left diagonal mode respectively. The prediction sample pred(x,y) is located at (x,y) in the prediction block. The reference sample R_{x′,-1} has a horizontal coordinate of x′=x+y+1 and a vertical coordinate of −1, and the reference sample R_{-1,y′} has a horizontal coordinate of −1 and a vertical coordinate of y′=x+y+1.

### ISP Prediction

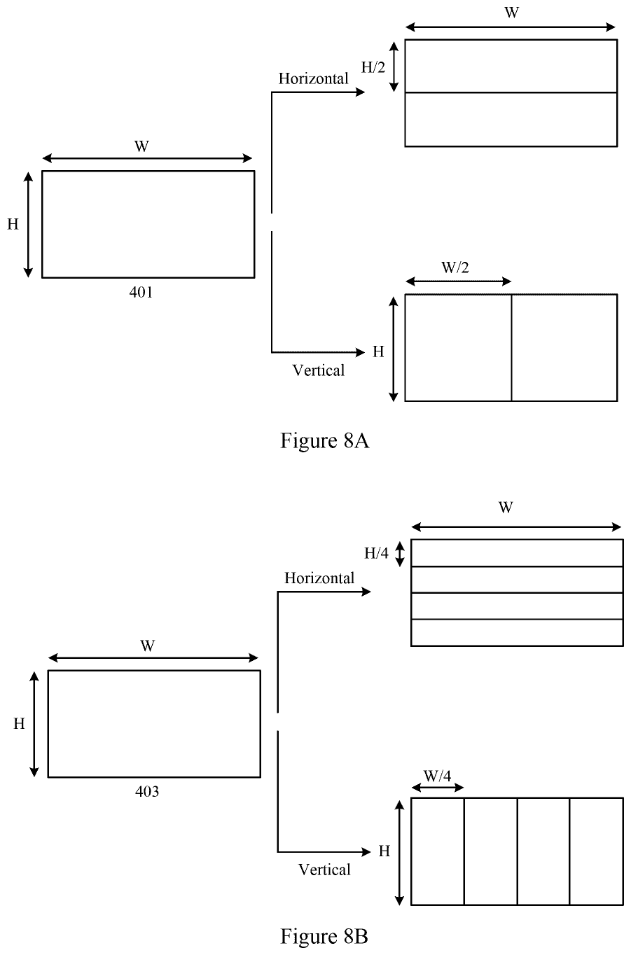

The ISP prediction is a tool applied for luma intra prediction modes, which divides luma video blocks vertically or horizontally into 2 or 4 sub-partitions depending on block sizes thereof, as shown in Table 2. For example, a minimum block size for ISP is 4×8 or 8×4. FIG. 8A and FIG. 8B show diagrams of sub-partitions depending on a block size. If a block size W×H of a video block (for example, the video block 401 as shown in FIG. 8A) is equal to 4×8 or 8×4, then the video block is divided into 2 sub-partitions. If a block size W×H of a video block (for example, the video block 403 as shown in FIG. 8B) is greater than 4×8 or 8×4, then the video block is divided into 4 sub-partitions. A CU size that may use ISP is restricted to a maximum of 64×64. All sub-partitions fulfill a condition of having at least 16 samples.

TABLE 2

| Block size | Number of sub-partitions |
|---|---|
| 4 × 4 | Not divided |
| 4 × 8 and 8 × 4 | 2 |
| All other feasible cases | 4 |

For each sub-partition, reconstructed samples are obtained by adding a residual signal to a prediction signal. Here, the residual signal is generated by processes such as entropy decoding, inverse quantization and inverse transform. The reconstructed samples of each sub-partition are available to generate prediction of a next sub-partition. In addition, a first sub-partition to be processed is the one containing a top-left sample of the CU, and after the first sub-partition is processed, the ISP prediction continues downwards (for horizontal splitting as shown in FIG. 8A and FIG. 8B) or rightwards (for vertical splitting as shown in FIG. 8A and FIG. 8B). All sub-partitions share the same intra prediction mode.

### CCLM Prediction

To reduce the cross-component redundancy, a CCLM prediction mode is used in VVC, wherein chroma samples of a CU are predicted based on reconstructed luma samples rec_L(i,j) of the CU by using a linear model as follows:

$${pred}_{C} ( i , j ) = α \cdot {rec}_{L}^{′} ( i , 1 ) + β \qquad ( 3 )$$

where pred_{C}(i, j) represents predicted chroma samples in the CU, rec_{L}′(i, j) represents down-sampled reconstructed luma samples of the CU which are obtained by performing down-sampling on the reconstructed luma samples rec_{L}(i, j), and α and β are linear model parameters which are derived from at most four neighboring chroma samples and their corresponding down-sampled luma samples. Suppose that a current chroma block has a size of W×H, then W′ and H′ are obtained as follows:
W′=W, H′=H when an LM mode is applied;
W′=W+H when an LM_A mode is applied;
H′=H+W when an LM_L mode is applied.

In the LM mode, above samples and left samples of the CU are used together to calculate the linear model coefficients; in the LM_A mode, only the above samples of the CU are used to calculate the linear model coefficients; and in the LM_L mode, only the left samples of the CU are used to calculate the linear model coefficients.

If locations of above samples of a chroma block are denoted as S [0,−1] . . . S [W′−1, −1] and locations of left samples of the chroma block are denoted as S [−1, 0] . . . S [−1, H′−1], positions of four neighboring chroma samples are selected as follows:
S [W′/4,−1], S [3*W′/4,−1], S [−1, H′/4] and S [−1, 3*H′/4] are selected as the positions of the four neighboring chroma samples when the LM mode is applied and both of the above and left samples are available;
S [W′/8,−1], S [3*W′/8,−1], S [5*W′/8,−1] and S [7*W′/8,−1] are selected as the positions of the four neighboring chroma samples when the LM_A mode is applied and the above samples are available or when only the above samples are available;
S [−1, H′/8], S [−1, 3*H′/8], S [−1, 5*H′/8] and S [−1, 7*H′/8] are selected as the positions of the four neighboring chroma samples when the LM_L mode is applied and the left samples are available or when only the left samples are available.

Four neighboring luma samples corresponding to the selected locations are obtained by a down-sampling operation and the obtained four neighboring luma samples are compared four times to find two larger values: x⁰_{A} and x¹_{A} and two smaller values: x⁰_{B} and x¹_{B}. Chroma sample values corresponding to the two larger values and the two smaller values are denoted as y⁰_{A}, y¹_{A}, y⁰_{B} and y¹_{B} respectively. Then Xₐ, X_{b}, Yₐ and Y_{b} are derived as:

$${X}_{a} = ( {x}_{A}^{0} + {x}_{A}^{1} + 1 ) >> 1 ; \qquad ( 4 )$$

$${X}_{b} = ( {x}_{B}^{0} + {x}_{B}^{1} + 1 ) >> 1 ;$$

$${Y}_{a} = ( {y}_{A}^{0} + {y}_{A}^{1} + 1 ) >> 1 ;$$

$${Y}_{b} = ( {y}_{B}^{0} + {y}_{B}^{1} + 1 ) >> 1.$$

Finally, the linear model parameters α and β are obtained according to the following equations.

$$α = \frac{{Y}_{a} - {Y}_{b}}{{X}_{a} - {X}_{b}} \qquad ( 5 )$$

$$β = {Y}_{b} - α \cdot {X}_{b}$$

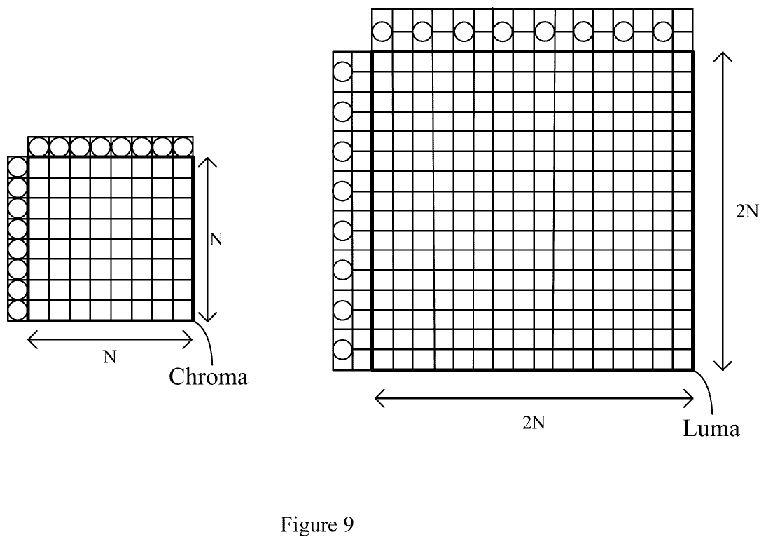

FIG. 9 shows a diagram of locations of left and above samples of the CU involved in the CCLM mode, including locations of left and above samples of an N×N chroma block 901 in the CU and locations of left and above samples of an 2N×2N luma block 903 in the CU.

The parameter computation described above is performed as part of the decoding process, and therefore no syntax element is used to convey values of α and β from the video encoder 20 to the video decoder 30.

### MIP

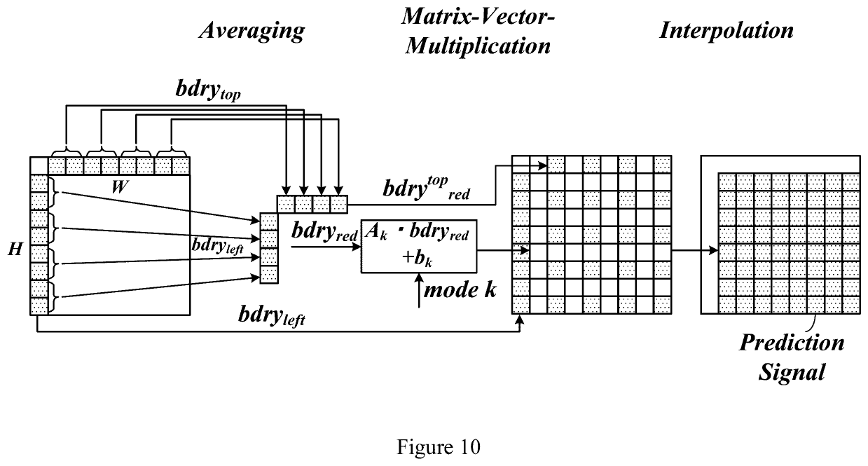

MIP is an intra prediction method newly added into VVC. In the MIP prediction method, a prediction signal of samples of a rectangular block of width W and height H is generated by taking one column of H reconstructed neighboring boundary samples left to the rectangular block and one row of W reconstructed neighboring boundary samples above the rectangular block as input based on the following three steps, which are averaging, matrix vector multiplication and linear interpolation as shown in FIG. 10.

### First Step: Averaging Neighboring Samples

Four samples or eight samples are determined by averaging the neighboring boundary samples bdryₜₒₚ and bdry_{left} based on block size and shape. Specifically, the neighboring boundary samples bdryₜₒₚ and bdry_{left} are reduced to boundary samples

$${bdry}_{red}^{top}$$

and

$${bdry}_{red}^{left}$$

by averaging the neighboring boundary samples bdryₜₒₚ and bdry_{left} according to a predefined rule depending on the block size. Then, the reduced boundary samples

$${bdry}_{red}^{top}$$

and

$${bdry}_{red}^{left}$$

are concatenated to a reduced boundary vector bdry_{red} which thus has a size of 4 for blocks of shape 4×4 and has a size of 8 for blocks of all other shapes. If Index_{mode} refers to the MIP-mode, this concatenation is defined as follows:

$${bdry}_{red} = \{ \begin{matrix}[ {bdry}_{red}^{top} , {bdry}_{red}^{left} ] & for W = H = 4 and {Index}_{mode} < 18 \\ [ {bdry}_{red}^{left} , {bdry}_{red}^{top} ] & for W = H = 4 and {Index}_{mode} \geq 18 \\ [ {bdry}_{red}^{top} , {bdry}_{red}^{left} ] & for max ( W , H ) = 8 and {Index}_{mode} < 10 \\ [ {bdry}_{red}^{left} , {bdry}_{red}^{top} ] & for max ( W , H ) = 8 and {Index}_{mode} \geq 10 \\ [ {bdry}_{red}^{top} , {bdry}_{red}^{left} ] & for max ( W , H ) > 8 and {Index}_{mode} < 6 \\ [ {bdry}_{red}^{left} , {bdry}_{red}^{top} ] & for max ( W , H ) > 8 and {Index}_{mode} \geq 6\end{matrix} . \qquad ( 6 )$$

### Second Step: Matrix Vector Multiplication

A matrix vector multiplication, followed by addition of an offset, is carried out with the averaged samples in the reduced boundary vector bdry_{red} as an input, to generate a reduced prediction signal of a down-sampled set of samples in the original block. More specifically, the reduced prediction signal pred_{red} is computed as:

$${pred}_{red} = A \cdot {bdry}_{red} + b \qquad ( 7 )$$

Here, A is a matrix that has W_{red}·H_{red} rows and 4 columns if W=H=4 or 8 columns in all other cases. b is an offset vector of size W_{red}·H_{red}.

Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 8 )$$

$${H}_{red} = \{ \begin{matrix}4 & for max ( W , H ) \leq 8 \\ min ( H , 8 ) & for max ( W , H ) > 8\end{matrix} \qquad ( 9 )$$

The matrix A and the offset vector b are taken from one of the sets S₀, S₁, S₂. An index idx of a set from which the matrix A and the offset vector b are taken is defined as follows:

$$idx = \{ \begin{matrix}0 & for W = H = 4 \\ 1 & for max ( W , H ) = 8 \\ 2 & for max ( W , H ) > 8\end{matrix} \qquad ( 10 )$$

Here, each coefficient of the matrix A is represented with 8-bit precision. The set S₀ consists of 16 matrices

$${A}_{0}^{i}$$

each of which has 16 rows and 4 columns and 16 offset vectors

$${b}_{0}^{i}$$

each of size 16, i∈{0, . . . , 15}. Matrices and offset vectors of that set are used for blocks of size 4×4. The set S₁ consists of 8 matrices

$${A}_{1}^{i}$$

each of which has 16 rows and 8 columns and 8 offset vectors

$${b}_{1}^{i}$$

each of size 16, i∈{0, . . . , 7}. The set S₂ consists of 6 matrices

$${A}_{2}^{i}$$

each of which has 64 rows and 8 columns and of 6 offset vectors

$${b}_{2}^{i}$$

of size 64, i∈{0, . . . , 5}.

### Third Step: Interpolation

The prediction signal at the remaining positions is generated from the reduced prediction signal of the down-sampled set of samples by linear interpolation which is a single step linear interpolation in each direction. The interpolation is performed firstly in the horizontal direction and then in the vertical direction regardless of block shape or block size.

### Intra Block Copy

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:

IBC skip/merge mode: a merge candidate index is used to indicate which of the block vectors in the list from neighboring candidate IBC coded blocks is used to predict the current block. The merge list includes spatial, HMVP, and pairwise candidates.

IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### Convolutional Cross-Component Model (CCCM) for Intra Prediction

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM, top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

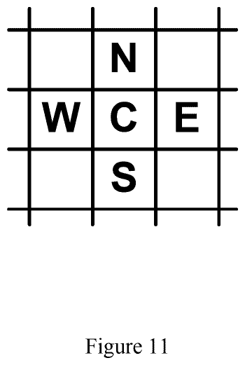

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 11.

The nonlinear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

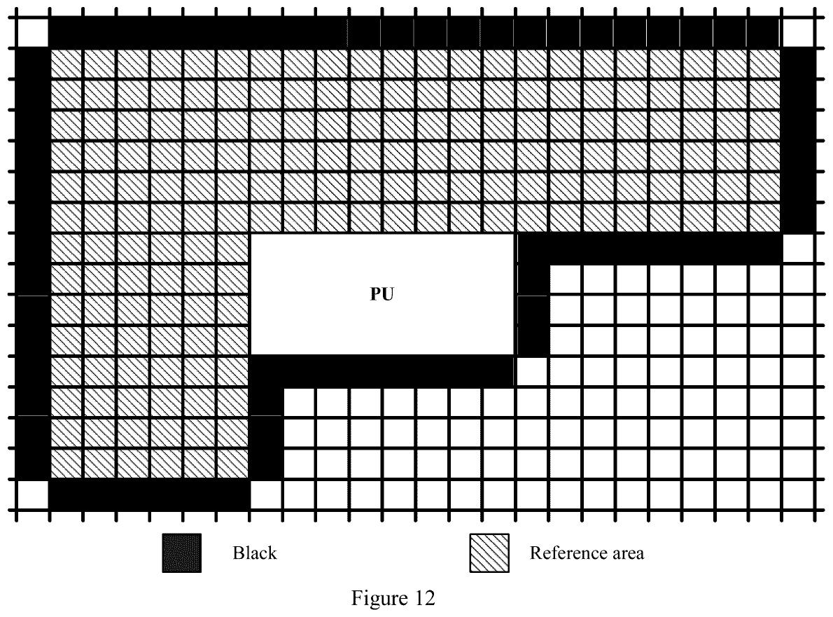

The filter coefficients cᵢ are calculated by minimizing MSE between predicted and reconstructed chroma samples in the reference area. FIG. 12 illustrates the reference area which consists of 2 or 6 lines of chroma samples above and left of the PU. Whether to use 6 lines or 2 lines of neighboring samples to derive the CCCM model parameters in the single model CCCM is determined by a template cost. Similarly, for the multi-model CCCM mode, the two candidates use 6 lines neighboring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area extends one PU width to the right and one PU height below the PU boundaries. Area is adjusted to include only available samples. The extensions to the area shown in black are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The sample values used in both model creation and final prediction (i.e., luma and chroma in the reference area, and luma in the current PU) are reduced by these fixed values, as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 ≪ ( bitDepth - 1 )$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation, the chroma offset is added to the bias term of the convolutional model.

The process of CCCM model parameter calculation requires division operations. Division operations are not always considered implementation friendly. The division operation is replaced with multiplication (with a scale factor) and shift operation, where scale factor and number of shifts are calculated based on denominator similar to the method used in calculation of CCLM parameters.

### Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

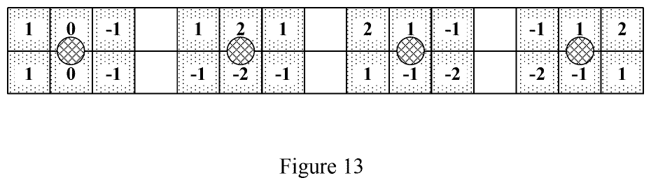

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation, as illustrated in FIG. 13.

### An Extrapolation Filter-Based Intra Prediction (EIP) Mode

The extrapolation filter-based intra prediction is processed in three steps. First, the minimum sample value, the maximum sample value and an offset value are obtained for a pre-determined reconstructed area (i.e., the template of the current block to be predicted). The values can be luma sample values or chroma sample values. Second, the extrapolation filter coefficients are obtained from the reconstructed sample values from the template. Third, the extrapolation process generates predicted sample values, sample by sample, from the top-left to bottom-right corner within the current block.

The application of EIP is restricted to the block size not greater than 32×32 and intra slice only.

Similar to CCCM mode, the offset value should be removed when feeding the inputs to the EIP filter. In one example, the offset value for EIP prediction can be the average sample value for the template. In another example, the sample value of a top-left reconstructed sample (adjacent to the current block) from the template of the current block is used as the offset value for EIP prediction. The minimum sample value and the maximum sample value are obtained from reconstructed samples in the template of the current block.

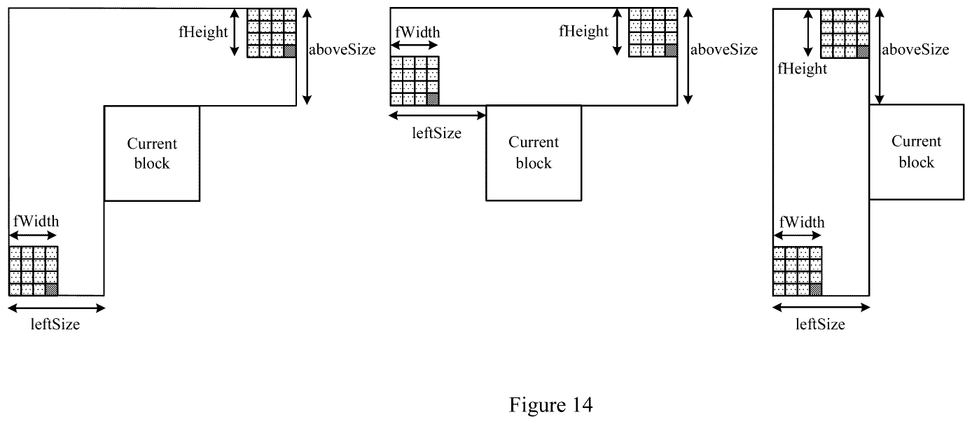

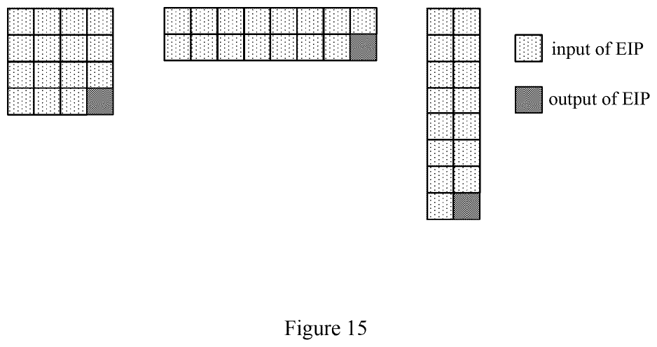

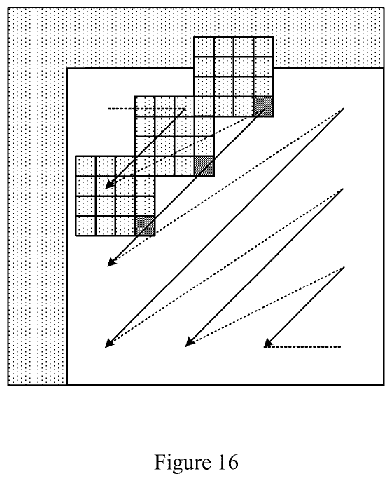

Three types of templates and three filter shapes are proposed as shown in FIG. 14 and FIG. 15. FIG. 14 illustrates three types of templates and a filter with a filter shape of 4×4 (the width of the filter (fWidth) being 4 samples, and the height of the filter (fHeight) being 4 samples). The size of each template depends on the minimum value among the width and height of the current block (i.e., min (blockWidth, blockHeight)) and the selected filter shape. For example, when the current block is an 8×16 block and the selected filter shape is 4×4, the aboveSize (number of lines above the current block) of the template is min(8, 16)+4−1=11, and the leftSize (number of lines to the left of the current block) of the template is min(8, 16)+4−1=11. Three types of fifteen-tap filters are shown in FIG. 15 for which the boxes with sparse dot pattern correspond to the input samples and the box with dense dot pattern corresponds to the output sample to be predicted. When the current block uses the proposed EIP mode for prediction, the decoder decodes the relevant syntax elements to determine the selected type of template and the filter shape for the current block.

The selected filter moves in the selected template with a one-sample step to collect input samples and output samples of EIP. The auto-correlation matrix and cross-correlation vector are constructed while removing the offset value from input samples and output samples. Then, the EIP coefficients are obtained by the same method in CCCM.

The EIP mode generates predictions for the current block from the top-left position to the bottom-right position by a diagonal prediction order, as shown in FIG. 16.

To reduce the prediction error, the minimum and maximum values from the template are applied to restrict the output range of each predicted value.

The calculation for predicted samples is shown as follows,

$${pred}_{( x , y )} = clip 3 ( min , max , {\sum }_{i = 0}^{14} ( {c}_{i} \times ( {t}_{( x - xoffset , y - yoffset )} - offset ) ) + offset )$$

where pred_{(x,y)} is the sample value to be predicted at (x, y) in the current block. min, max and offset are the values corresponding to the minimum sample value, the maximum sample value and the offset value described above in relation to EIP. cᵢ is the i^{th} coefficient of the derived EIP filter, the index of the coefficients in this example is from 0 to 14 (as shown by the first square 4×4 filter shape for which the boxes with sparse dot pattern correspond to the 0˜14 input samples and the box with dense dot pattern corresponds to the output sample to be predicted), t_{(x-xoffset,y-yoffset)} is a reconstructed or predicted value used for the current position's prediction. clip3 corresponds to the function as illustrated in equation (2).

Although the existing extrapolation filter-based intra prediction mode can provide significant improvement of intra coding in the ECM, there is room to further improve its performance. Meanwhile, some parts of the existing extrapolation filter-based intra prediction mode also need to be simplified for efficient codec hardware implementations or improved for better coding efficiency. Furthermore, the tradeoff between its implementation complexity and its coding efficiency benefit needs to be further improved.

In this disclosure, to address the issues as pointed out above, methods are provided to further improve the existing design of extrapolation filter-based intra prediction mode (EIP). In general, the main features of the proposed technologies in this disclosure are summarized as follows.

In one example, the template may be adjacent to the current block. Reference from local regions can improve the accuracy of prediction in prediction.

In one example, the template may be not adjacent to the current block. In this example, reference from non-local regions can improve the accuracy of prediction in prediction.

In one example, only one hypothesis may be utilized. For example, the combination of different templates and filter shapes will lead to different predicted blocks. The best matching block which leads to the minimum matching cost is selected as the final prediction.

In another example, multiple hypothesis may be utilized. For example, more than one predicted blocks are further fused as the final prediction for the current block.

In one example, extrapolation filter-based sub-partitions is proposed to further improve the prediction accuracy of the extrapolation filter-based prediction mode.

In one example, classification-based methods of extrapolation filter-based prediction is proposed to further improve the prediction accuracy of the extrapolation filter-based prediction mode.

It is noted that the figures in this disclosure may be combined with all examples mentioned in this disclosure.

It is noted that the disclosed methods may be applied independently or jointly.

### Improvement of EIP

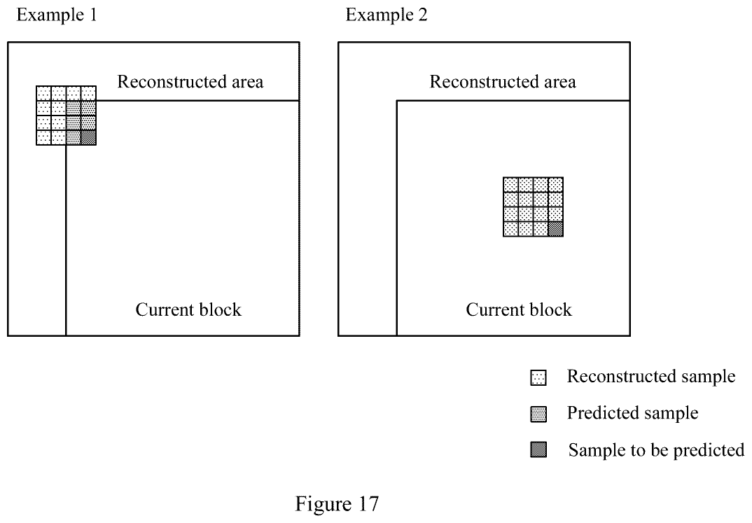

According to one or more embodiments of the disclosure, reconstructed samples in the template and/or predicted samples in the current block may be used as inputs to the filter when generating predictions, depending on the location of the sample to be predicted. Example 1 of FIG. 17 illustrates using both reconstructed samples in the template and predicted samples in the current block for predicting the sample to be predicted, while Example 2 of FIG. 17 illustrates using only predicted samples in the current block for the generating a prediction for the sample to be predicted.

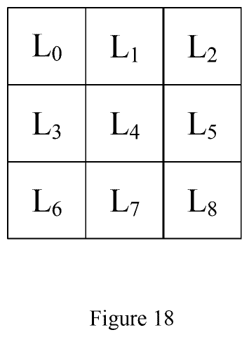

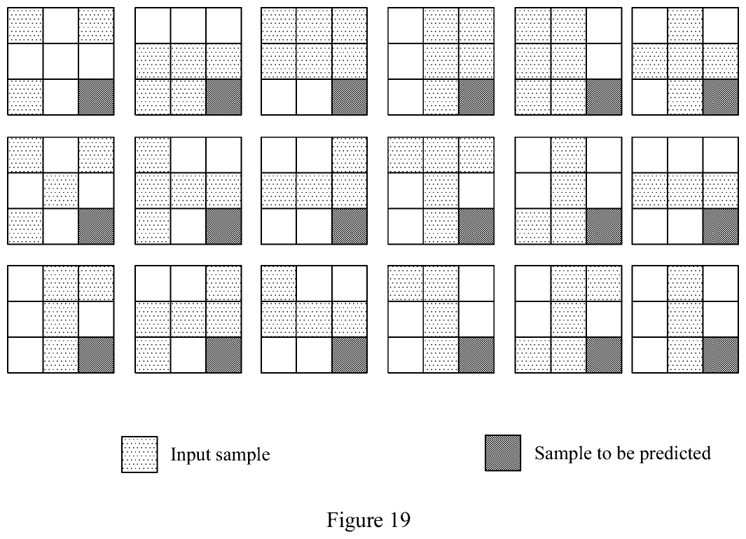

According to one or more embodiments of the disclosure, the convolutional N-tap (N is an integer and larger than 1) filter may include (N−1−M)-tap (M is an integer) spatial terms, M nonlinear terms and a bias term. The (N−1−M)-tap spatial terms correspond to neighboring samples (e.g., L₀, L₁, . . . , L₇ as shown in the exemplary filter in FIG. 18) for the sample to be predicted (e.g., L₈ in FIG. 18). The formula for each new sample to be predicted is as follows:

$$precVal = {\sum }_{i = 0}^{N - 2 - M} {α}_{i} \cdot ( {L}_{i} - offsetLuma ) + {\sum }_{i = 0}^{M - 1} {α}_{i + N - N - 1 - M} \cdot ( ( {( {L}_{i} - offsetLuma )}^{2} + β ) ≫ bitDepth ) + {α}_{N - 1} \cdot β + offsetLuma$$

where αᵢ is the coefficient associated with Lᵢ and β is an offset (i.e., 1<< (bitDepth−1)). The position and number of spatial term and nonlinear term may be different. Examples of different shape/number of filter taps are illustrated in FIG. 19. For other examples, different positions of input samples and number of filter taps are shown in following table.

| Number of terms | Position of terms (L₈ being the sample to be predicted) |
|---|---|
| 1 | Any one of {L₀, L₁, L₂, L₃, L₄, L₅, L₆, L₇}, i.e., (L₀) or (L₁) or (L₂) |
| | or (L₃) or (L₄) or (L₅) or (L₆) or (L₇) |
| 2 | Any two of {L₀, L₁, L₂, L₃, L₄, L₅, L₆, L₇}, e.g., (L₀, L₁) or (L₀, L₂) |
| | or (L₀, L₃) or (L₀, L₄) or (L₀, L₅) or (L₁, L₂) or (L₁, L₃) or (L₁, L₄) or |
| | (L₁, L₅) or (L₂, L₃) or (L₂, L₄) or (L₂, L₅) or (L₃, L₄) or (L₃, L₅) or (L₄, |
| | L₅) |
| 3 | Any three of {L₀, L₁, L₂, L₃, L₄, L₅, L₆, L₇}, e.g., (L₀, L₁, L₂) or (L₀, |
| | L₁, L₃) or (L₀, L₁, L₄) or (L₀, L₁, L₅) or (L₀, L₂, L₃) or (L₀, L₂, L₄) or |
| | (L₀, L₂, L₅) or (L₀, L₃, L₄) or (L₀, L₃, L₅) or (L₀, L₄, L₅) or (L₁, L₂, L₃) |
| | or (L₁, L₂, L₄) or (L₁, L₂, L₅) or (L₁, L₃, L₄) or (L₁, L₃, L₅) or (L₁, L₄, |
| | L₅) or (L₂, L₃, L₄) or (L₂, L₃, L₅) or (L₂, L₄, L₅) or (L₃, L₄, L₅) |
| 4 | Any four of {L₀, L₁, L₂, L₃, L₄, L₅, L₆, L₇}, e.g., (L₂, L₃, L₄, L₅) or |
| | (L₁, L₃, L₄, L₅) or (L₁, L₂, L₄, L₅) or (L₁, L₂, L₃, L₅) or (L₁, L₂, L₃, L₄) |
| | or (L₀, L₃, L₄, L₅) or (L₀, L₂, L₄, L₅) or (L₀, L₂, L₃, L₅) or (L₀, L₂, L₃, |
| | L₄) or (L₀, L₁, L₄, L₅) or (L₀, L₁, L₃, L₅) or (L₀, L₁, L₃, L₄) or (L₀, L₁, |
| | L₂, L₅) or (L₀, L₁, L₂, L₄) or (L₀, L₁, L₂, L₃) |
| 5 | Any five of {L₀, L₁, L₂, L₃, L₄, L₅, L₆, L₇}, e.g., (L₀, L₁, L₂, L₃, L₄) |
| | or (L₀, L₁, L₂, L₃, L₅) or (L₀, L₁, L₂, L₄, L₅) or (L₀, L₁, L₃, L₄, L₅) or |
| | (L₀, L₂, L₃, L₄, L₅) or (L₁, L₂, L₃, L₄, L₅) |
| 6 | Any six of {L₀, L₁, L₂, L₃, L₄, L₅, L₆, L₇}, e.g., (L₀, L₁, L₂, L₃, L₄, L₅) |
| 7 | Any seven of {L₀, L₁, L₂, L₃, L₄, L₅, L₆, L₇}, e.g., (L₀, L₁, L₂, L₃, L₄, |
| | L₅, L₆) |
| 8 | (L₀, L₁, L₂, L₃, L₄, L₅, L₆, L₇) |

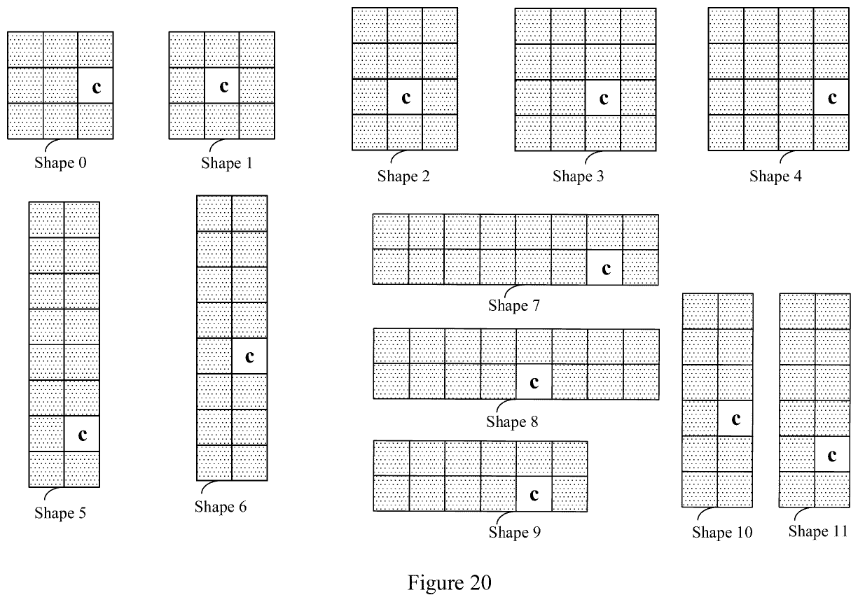

According to one or more embodiments of the disclosure, the filter shape may be rectangle and does not include the sample to be predicted, with N*M−1 filter taps (N and M are integers and larger than 1). Examples of different shape/number of filter taps are further illustrated in FIG. 20. According to one or more embodiments of the disclosure, the corresponding center point (C) position (i.e., the sample to be predicted) can be different and not at the bottom right corner of the filter. In these examples, unavailable sample values may be padded from neighboring samples. Examples of different positions of center point (C) are illustrated in FIG. 20.

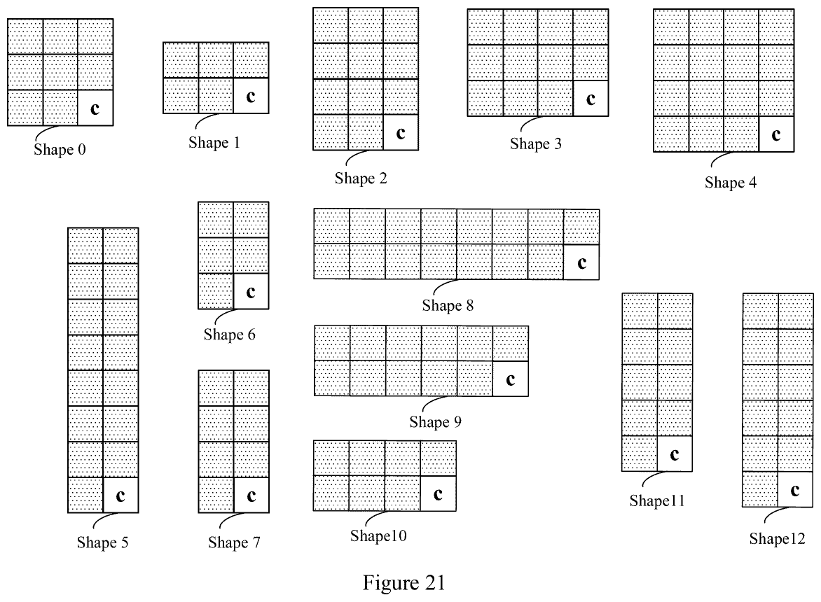

According to one or more embodiments of the disclosure, the filter shape may be rectangle and does not include the bottom right sample (i.e., the sample to be predicted), the number of filter taps used are N*M−1 (N and M are integers and larger than 1). Examples of different shape/number of filter taps are illustrated in FIG. 21, where (C) is the corresponding center point position (i.e., the location of the sample to be predicted).

According to one or more embodiments of the disclosure, the number of filter taps may be predefined or signaled/switched in different coding levels such as the SPS/DPS/VPS/SEI/APS/PPS/PH/SH/Region/CTU/CU/Subblock/Sample levels.

According to one or more embodiments of the disclosure, the template size used for deriving the filter coefficients may be N lines above and to the left of the current block depending on their availability, Nis an integer.

According to one or more embodiments of the disclosure, the template size used for deriving the filter coefficients may be N lines above of the current block depending on their availability, N is an integer.

According to one or more embodiments of the disclosure, the template size used for deriving the filter coefficients may be N lines left of the current block depending on their availability, N is an integer.

According to one or more embodiments of the disclosure, the template size used for deriving the filter coefficients may depend on the filter shape. In one example, if the height of filter shape is greater than its width, the template size may be N lines above of the current block depending on their availability, N is an integer.

According to one or more embodiments of the disclosure, the template may be predefined or signaled/switched in different coding levels such as the SPS/DPS/VPS/SEI/APS/PPS/PH/SH/Region/CTU/CU/Subblock/Sample levels.

According to one or more embodiments of the disclosure, location information may be used to calculate model parameters, including utilizing horizontal/vertical/diagonal distance and their non-linear term, one or more location information may be used for the purpose. In one example, the location based parameter is related to the vertical and horizontal coordinates (Xc, Yc) of the center luma sample and it is calculated with respect to the top-left coordinates (Xtl, Ytl) of the block, e.g. Xc−Xtl+Yc−Ytl. In another example, the location based parameters are related to the vertical and horizontal coordinates (Xc, Yc) of the center luma sample and they are calculated with respect to the top-left coordinates (Xtl, Ytl) of the block, e.g. Xc−Xtl+Yc−Ytl, Xc−Xtl, Yc−Ytl. In yet another example, the location based parameter is related to the vertical and horizontal coordinates (Xc, Yc) of the center luma sample and it is calculated with respect to the top-left coordinates (Xtl, Ytl) of the block, e.g. (Xc−Xtl+Yc−Ytl)/N, where N is predefined number, such as 2. In yet another example, the location based parameters are related to the vertical and horizontal coordinates (Xc, Yc) of the center luma sample and they are calculated with respect to the top-left coordinates (Xtl, Ytl) of the block, e.g. (Xc−Xtl+Yc−Ytl)/N1, (Xc−Xtl)/N2, (Yc−Ytl)/N3, where N1˜N3 are predefined numbers, such as 2, 3 and 4. In yet another example, the location based nonlinear terms are represented as power of two of the horizontal/vertical/diagonal distance, e.g. (Xc−Xtl+Yc−Ytl)*(Xc−Xtl+Yc−Ytl), (Xc−Xtl)*(Xc−Xtl), (Yc−Ytl)*(Yc−Ytl), where (Xc, Yc) are vertical and horizontal coordinates of the center luma sample and (Xtl, Ytl) are top-left coordinates.

According to one or more embodiments of the disclosure, one enable flag can be signaled in the bitstream to indicate the EIP mode used. The enable flag can be signaled in different coding levels such as the SPS/DPS/VPS/SEI/APS/PPS/PH/SH/Region/CTU/CU/Subblock/Sample levels.

According to one or more embodiments of the disclosure, instead of explicitly signaling the selected mode flag, the mode flag can be derived at decoder to save bit overhead.

According to one or more embodiments of the disclosure, no additional control flag is required and the EIP mode will be derived under some predefined condition (e.g., specific modes, specific block sizes, specific partitions, etc.). When the predefined condition is matched, the EIP mode will be derived based on previous decoded information.

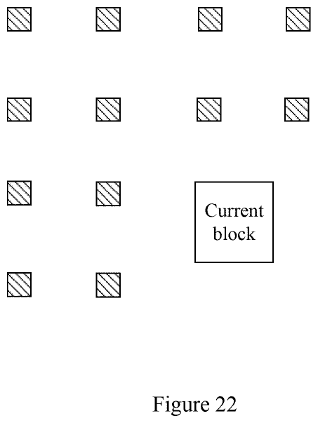

According to one or more embodiments of the disclosure, samples in regions non-adjacent to the current block can be used to derive a model for the current block. In such case, the template is selected from a plurality of template candidates in candidate regions. In one embodiment, one candidate region list with N candidates may be constructed by checking potential M×M regions in order. If a checked region is available, it is put into the candidate region list. For example, a candidate region list with 6 candidates is constructed by checking potential 8×8 regions in order. The top-left positions of the potential 8×8 regions are predetermined as {(−xStep, 0), (0,−yStep), (xStep,−yStep), (−xStep, yStep), (−xStep,−yStep), (−2*xStep, 0), (0,−2*yStep), (−2*xStep, 2*yStep), (2*xStep,−2*yStep), (−2*xStep, yStep), (xStep,−2*yStep), (−2*xStep,−yStep), (−xStep,−2*yStep), (−2*xStep,−2*yStep), (−xStep/2, 0), (0,−yStep/2), (xStep/2,−yStep/2), (−xStep/2, yStep/2), (−xStep/2,−yStep/2)}, where xStep=Max (width, 16), yStep=Max (height, 16). FIG. 22 show some possible positions of candidate regions.

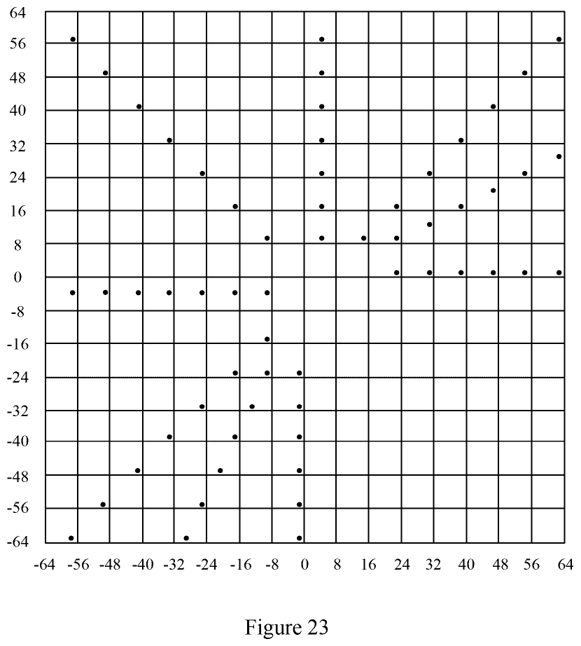

According to one or more embodiments of the disclosure, one candidate region list with N candidates may be constructed by positions and inclusion order of the spatial non-adjacent neighboring candidates from two sets of spatial non-adjacent neighboring candidates in inter merge mode. If a checked region is available, it is put into the candidate region list. FIG. 23 show some possible positions of candidates.

According to one or more embodiments of the disclosure, inherited flags of EIP from previously decoded block at the same or different coding levels, such as the CU/TB/CB/slice/picture/sequence level may be used in the current block. According to one or more embodiments of the disclosure, one control flag is signaled in CU/TB/CB/slice/picture/sequence level to indicate whether the signaling of inherited EIP is enabled or disabled. When the control flag is signaled as enabled, a flag of inherited EIP is further signaled to decoder to indicate whether the inherited EIP is used or not at the signaled level.

According to one or more embodiments of the disclosure, the filter shape and the derived parameters for the filter of EIP from previous decoded block at the same or different coding levels, such as the CU/TB/CB/slice/picture/sequence level, can be stored and used for the current block using EIP (which is called inherited EIP). In one or another embodiment, a history-based EIP (H-EIP) table may be maintained similar to the HMVP table. The history-based EIP table comprises a set of video blocks predicted with EIP mode previously. In one embodiment, one index value can be signaled in the bitstream to indicate which candidate model in the H-EIP table is selected. In one embodiment, after decoding an EIP coded block, the corresponding table may be updated. In one embodiment, the size of H-EIP table is N. N is an integer (e.g. 4, 5, 6, 7).

According to one or more embodiments of the disclosure, the filter coefficient precision in this method may be reduced. In other words, the precision of the stored filter coefficients for predicting the sample values of the current block may be reduced compared with the precision of derived filter coefficients used for predicting the sample values of the previous decoded block (e.g., from 12 bits to 8 bits or 10 bits, or from 10 bits to 8 bits).

### Multi-Hypothesis EIP

According to one or more embodiments of the disclosure, more than one prediction for the current block are used and weighted to generate the final prediction of the current block. Assuming that N prediction block candidates are used, N being an integer (e.g. 2, 3, 4, 5), at least one of the candidates is based on EIP to implement Multi-hypothesis EIP. For example, a prediction block candidate may be obtained based on inherited EIP, while other prediction block candidates may be calculated based on EIP with different filter shapes and/or different templates.

In one embodiment, the prediction block candidates are searched and selected according to the criterion of minimizing template matching cost, i.e., the top N candidates which lead to the minimum template matching cost are selected. The template matching cost can be not limited to SAD (sum of absolute difference) and SSE (sum of square error).

In one embodiment, at least one of the prediction block candidates may be selected according to a predefine mode other than EIP, i.e., planar mode, IBC prediction, etc.

In one embodiment, at least one of the prediction block candidates may be selected according to a neighbor predefine mode, i.e., top predefine mode, left predefine mode, etc.

In one embodiment, the IBC prediction is combined with extrapolation filter-based intra prediction mode to increase prediction accuracy and adapt the characteristics of the copied block to the local neighborhood.

In one embodiment, the weighting factors to generate the final prediction block are predefined and fixed at both the encoder and decoder side. As an example, equal weighting factors can be used, i.e., 1/N for all the candidate blocks.

In one embodiment, the weighting factors can be derived based on the template matching costs. Denote the template matching costs of the N candidates as C₁, C₂, . . . , CN, the weighting factors are calculated as follow.

$${ω}_{i} = \frac{1}{N - 1} - \frac{{c}_{i}}{( N - 1 ) {\sum }_{i = 1}^{N} {c}_{k}} , i = 1 , 2 , … , N \qquad ( 11 )$$

It should be noted that the template matching cost can be measured with (but not limited to) SAD and SSE.

In yet another embodiment, the weighting factors can be derived/switched based on the block size or syntax element signaled in different coding levels such as the SPS/DPS/VPS/SEI/APS/PPS/PH/SH/Region/CTU/CU/Subblock/Sample levels.

In yet another embodiment, the weighting factors can be derived at the encoder side and then signaled in the bitstream to the decoder. Denote the N prediction block candidates as P₁, P₂, . . . , P_{N} and the current block as X, then the weighting factors can be solved by the following equation:

$${\sum }_{i = 1}^{N} {ω}_{i} {P}_{i} = X \qquad ( 12 )$$

Equation (12) can be solved using Wiener-Hopf equations as ALF. The derived filter coefficients are then quantized to integer type and signaled in the block level.

In yet another embodiment, the weighting factors are derived based on the templates and the derived weighting factors are applied to the prediction block candidates to generate the final prediction block. Denote the templates of the prediction candidates as T₁, T₂, . . . , IN and the current block as T, then the weighting factors can be derived using the following equation:

$${\sum }_{i = 1}^{N} {ω}_{i} {T}_{i} = T \qquad ( 13 )$$

Equation (13) can be solved using Wiener-Hopf equations. Then the final prediction block can be calculated as

$${\sum }_{i = 1}^{N} {ω}_{i} {P}_{i} ,$$

where Pᵢ represents the i-th prediction block candidate.

EIP mode exploits the nonlocal correlation to improve the prediction accuracy, in which similar blocks are searched and used to generate the final prediction block. In this embodiment, it is proposed to combine the nonlocal mean filtering and multi-hypothesis EIP, which is described as follow. In the first step, N prediction block candidates are searched and identified as conducted in the EIP. In the second step, the weighting factor is calculated as follows.

$${ω}_{i} = \frac{1}{Z [ i ]} {e}^{- \frac{{D}_{i}}{{h}^{2}}} \qquad ( 14 )$$

where Dᵢ is used to measure the distance between the template of the i-th prediction block candidate and the template of the current block, h is used as the degree of weighting and Z[i] is the normalization constant:

$$Z [ i ] = {\sum }_{i = 1}^{N} {e}^{- \frac{{D}_{i}}{{h}^{2}}} \qquad ( 15 )$$

To calculate the weighting factor in equation (14), the strength of weighting should be determined first. In this disclosure, several methods are proposed to decide the weighting strength.
In the first method, a weighting strength candidate list including some typical weighting strength values is defined and fixed at both encoder and decoder side. At the encoder side, the weighting strength values are checked using rate distortion optimization and the optimal weighting strength value is identified and signaled in the bitstream to the decoder side.
In the second method, the weighting strength value is estimated using the template of the prediction block candidates and the template of the current block. Denote the templates of the prediction candidates as T₁, T₂, . . . , T_{N} and the current block as T. Then the weighting strength value can be solved using the following equation:

$${\sum }_{i = 1}^{N} {ω}_{i} {T}_{i} = {\sum }_{i = 1}^{N} \frac{1}{Z [ i ]} {e}^{- \frac{{D}_{i}}{{h}^{2}}} {T}_{i} = T \qquad ( 16 )$$

In the third method, the weighting strength value can be estimated using the QP value and variance of the template of the current block, i.e., the relationship between the weighting strength value, QP value and the template variance can be fitted offline.

To better exploit the nonlocal correlation in the EIP, in this embodiment singular value decomposition (SVD) is utilized to generate the final prediction block from the prediction block candidates. The width and height of the current block are denoted as W and H, the area of the current block is denoted as d=H×W.
Step1. K prediction block candidates yᵢ are searched and identified as conducted in the EIP.
Step2. The K prediction block candidates of the current block y construct the block group G and are arranged as a matrix:

$${Y}_{G} = [ {y}_{G}^{( 1 )} , {y}_{G}^{( 2 )} , … , {y}_{G}^{( K )} ] \qquad ( 17 )$$

where Y_{G} is a matrix with size of d×K by arranging every candidate in group G as a column vector.
Step3. Perform SVD decomposition on the matrix Y_{G}.

$$S V D ( {Y}_{G} ) = {U}_{G} {Λ}_{G} {V}_{G}^{*} \qquad ( 18 )$$

Step4. Apply soft-thresholding operation on the singular value matrix Λ_{G}.

$${Λ}_{{G}_{i} , τ} = softTh ( {Λ}_{G} , τ ) \qquad ( 19 )$$

where softTh( ) is a function which shrinks the diagonal elements of Λ_{G} with the threshold τ. For the k-th diagonal element in Λ_{G}, it is shrunken by the nonlinear function D_{τ(k)} at level τ(k):

$${D}_{τ ( k )} : {λ}_{k , τ ( k )} = max ( \vert {λ}_{k} \vert - τ ( k ) , 0 ) \qquad ( 20 )$$

Λ_{G,τ} is the matrix composed of the shrunken singular values, λ_{k,τ}(k) at diagonal positions.
Step5. Perform inverse SVD to obtain the filtered patch group.

$${\hat{X}}_{G} = {U}_{G} {Λ}_{G , τ} {V}_{G}^{*} \qquad ( 21 )$$

One of the key steps is to determine the thresholding values for each diagonal element in step 4. In this invention, the thresholding values are calculated as follows. The threshold is estimated for each group of image patches with the following equation:

$${τ}_{G} ( k ) = c \times \frac{{σ}_{n , G}^{2}}{{σ}_{x , G , k}} \qquad ( 22 )$$

where σ_{n,G} is the standard deviation of noise, and σ_{x,G,k} is the standard deviation of the original block in the k-th dimension of SVD space for group G. The deviation of the original block in SVD space is estimated as follows,

$${σ}_{x , G , k} = \sqrt{max ( \frac{{λ}_{G , k}^{2}}{min ( d , K )} - ω \times {σ}_{n , G}^{2} , 0 )} \qquad ( 23 )$$

where

$${λ}_{G , k}^{2}$$

is the k-th singular value of Y_{G}_{ᵢ}. When σ_{x,G,k} is zero, the soft-thresholding operation is skipped. In addition, the deviation of noise is estimated with the deviation of the predicted block using a power function which is parameterized with α and β.

$${σ}_{n} = α \times {σ}_{y}^{β} \qquad ( 24 )$$

where σ_{y} is calculated as follows,

$${σ}_{y} = \frac{1}{K} {\sum }_{k = 0}^{K} \sqrt[2]{{\sum }_{i = 1}^{{p}^{2}} \frac{{( {y}_{k} ( i ) - {μ}_{k} )}^{2}}{{p}^{2}}} , {μ}_{k} = \frac{1}{{p}^{2}} {\sum }_{i = 1}^{{p}^{2}} {y}_{k} ( i ) \qquad ( 25 )$$

Here yₖ(i) represents the i-th pixel of prediction block candidate vector yₖ.

### Multi-Hypothesis EIP Signaling

In this disclosure, the proposed multi-hypothesis EIP can be utilized as a replacement of the current EIP mode or the encoder can adaptively select EIP mode or multi-hypothesis EIP mode.

In one embodiment, the proposed multi-hypothesis EIP is used as a replacement of the current EIP mode, i.e., always using multiple hypothesis for prediction. In yet another embodiment, one of the multi-hypothesis EIP methods in the above sections is used jointly with the current EIP mode. A flag is signaled in the bitstream to indicate whether multi-hypothesis EIP mode is applied to the CU.

In yet another embodiment, more than one multi-hypothesis EIP method in the above sections is used jointly with the current EIP mode. A flag is firstly signaled in the bitstream to indicate whether multi-hypothesis EIP mode is applied. Then an index is signaled to indicate which of the multi-hypothesis EIP methods is applied to the CU.

### Extrapolation Filter-Based Sub-Partitions

According to the embodiments of this disclosure, extrapolation filter-based sub-partitions (EISP) is proposed to further improve the prediction accuracy of the extrapolation filter-based prediction mode.

In one example, the EISP prediction may be applied for luma intra prediction modes, which divides luma video blocks vertically or horizontally into 2 or 4 sub-partitions depending on block sizes thereof, as shown in Table 2. For example, a minimum block size for EISP is 4×8 or 8×4. FIG. 8A and FIG. 8B show diagrams of sub-partitions depending on a block size. If a block size W×H of a video block (for example, the video block 401 as shown in FIG. 8A) is equal to 4×8 or 8×4, then the video block is divided into 2 sub-partitions. If a block size W×H of a video block (for example, the video block 403 as shown in FIG. 8B) is greater than 4×8 or 8×4, then the video block is divided into 4 sub-partitions. A CU size that may use EISP is restricted to a maximum of 64×64. All sub-partitions fulfill a condition of having at least 16 samples.

For each sub-partition, reconstructed samples are obtained by adding a residual signal to a prediction signal. Here, the residual signal is generated by processes such as entropy decoding, inverse quantization and inverse transform. The prediction signal is obtained by predicting sample values of the sub-partition with EIP mode. The reconstructed samples of each sub-partition are available to generate prediction of a next sub-partition. In this way, compared with EIP prediction for the video block, sub-partitioning enables more reconstructed samples to participate in the prediction of the block. In addition, a first sub-partition to be processed is the one containing a top-left sample of the CU, and after the first sub-partition is processed, the EISP prediction continues downwards (for horizontal splitting as shown in FIG. 8A and FIG. 8B) or rightwards (for vertical splitting as shown in FIG. 8A and FIG. 8B) for adjacent sub-partitions. All sub-partitions share the same EIP mode.

### Classification Based Methods of Extrapolation Filter-Based Prediction

According to the embodiments of this disclosure, classification-based methods of extrapolation filter-based prediction is proposed to further improve the prediction accuracy of the extrapolation filter-based prediction mode.

According to one or more embodiments of the disclosure, the methods comprise classifying the reconstructed luma samples into plural sample groups based on direction and strength of edge information and applying different EIP models to the reconstructed luma samples in different sample groups. Different methods may be used to achieve this goal.

According to one or more embodiments of the disclosure, the current sample (Y0) may be compared with neighboring N samples (Yi) to get a score, i.e., if Y0>Yi then score+=1, else Y0<Yi then score−=1. The score may be quantized to form K classes. Then the current sample may be classified to K classes by its score. N and K are integers.

According to one or more embodiments of the disclosure, the current sample may be calculated with neighboring N samples to get an edge strength, i.e., one edge strength is calculated by subtracting the current sample and one neighbor sample. The edge strength may be quantized to K segments by K−1 thresholds Ti. Then the current sample may be classified to K classes by its edge strength. N and K are integers.

According to one or more embodiments of the disclosure, the current sample may be calculated with neighboring N samples to get an edge strength, i.e., one edge strength is calculated by one edge detection filter. The filter shape, filter taps, and mapping table may be predefined or signaled or switched in different coding levels such as the SPS/DPS/VPS/SEI/APS/PPS/PH/SH/Region/CTU/CU/Subblock/Sample levels. The edge strength may be quantized to K segments by K−1 thresholds Ti. Then the current sample may be classified to K classes by its edge strength. N and K are integers.

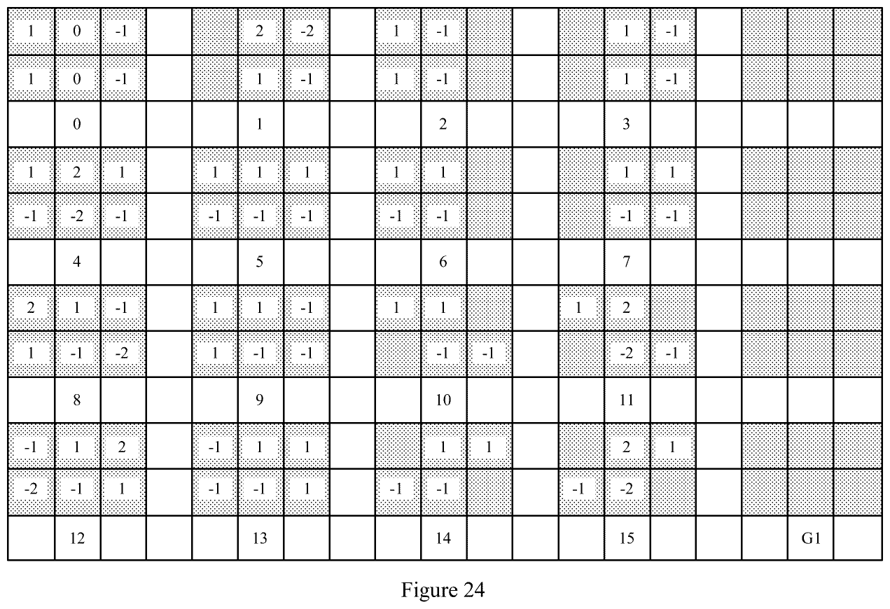

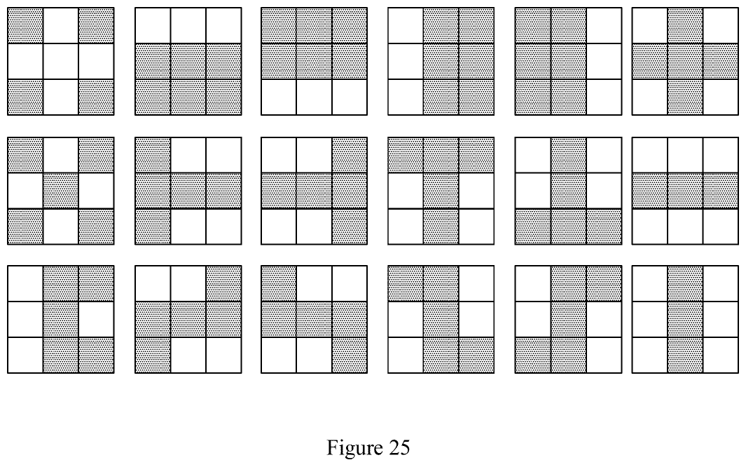

In one example, different filter shapes and filter taps for classification may be designed as in FIG. 24 and FIG. 25.

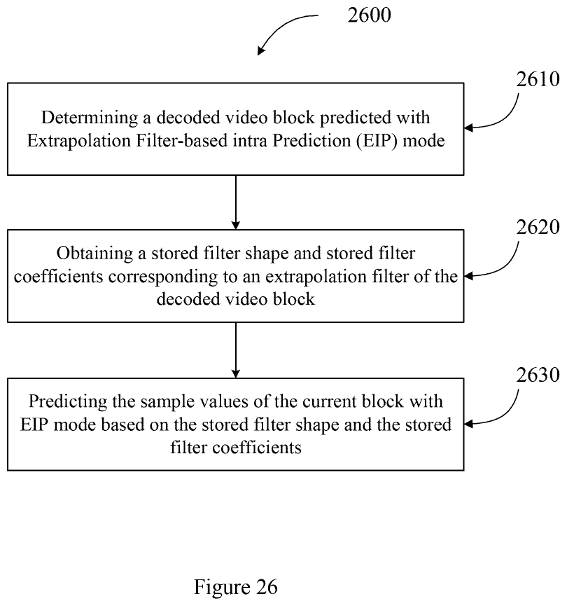

FIG. 26 illustrates a workflow of a method 2600 for video decoding according to one or more aspects of the present disclosure.

At step 2610, the method 2600 comprises determining a decoded video block predicted with Extrapolation Filter-based intra Prediction (EIP) mode.

At step 2620, the method 2600 comprises obtaining a stored filter shape and stored filter coefficients corresponding to an extrapolation filter of the decoded video block.

At step 2630, the method 2600 comprises predicting the sample values of the current block with EIP mode based on the stored filter shape and the stored filter coefficients.

In one example, the method 2600 further comprises determining that the current block is to be predicted with EIP mode in response to determining the decoded video block was predicted with EIP mode.

In one example, the determining the decoded video block comprises: obtaining a history-based EIP table comprising a set of video blocks predicted with EIP mode; and selecting one of the set of video blocks as the decoded video block based on an index value received in a bitstream.

In one example, the precision of the stored filter coefficients for predicting the sample values of the current block is reduced compared with the precision of derived filter coefficients used for predicting the sample values of the decoded video block.

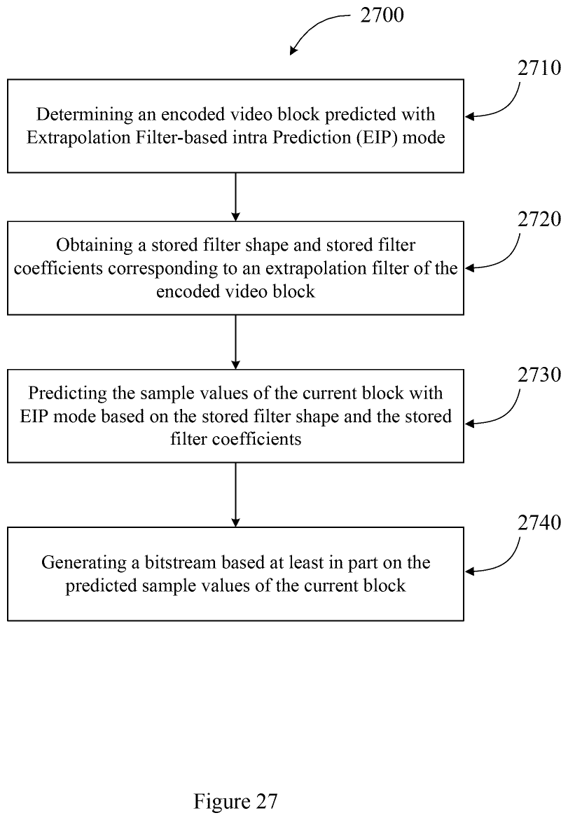

FIG. 27 illustrates a workflow of a method 2700 for video encoding according to one or more aspects of the present disclosure.

At step 2710, the method 2700 comprises determining an encoded video block predicted with Extrapolation Filter-based intra Prediction (EIP) mode.

At step 2720, the method 2700 comprises obtaining a stored filter shape and stored filter coefficients corresponding to an extrapolation filter of the encoded video block.

At step 2730, the method 2700 comprises predicting the sample values of the current block with EIP mode based on the stored filter shape and the stored filter coefficients.

At step 2740, the method 2700 comprises generating a bitstream based at least in part on the predicted sample values of the current block.

In one example, the method 2700 further comprises determining that the current block is to be predicted with EIP mode in response to determining the encoded video block was predicted with EIP mode.

In one example, the determining the encoded video block comprises: obtaining a history-based EIP table comprising a set of video blocks predicted with EIP mode; and determining one of the set of video blocks as the encoded video block to be signaled by an index value in a bitstream.

In one example, the precision of the stored filter coefficients for predicting the sample values of the current block is reduced compared with the precision of derived filter coefficients used for predicting the sample values of the encoded video block.

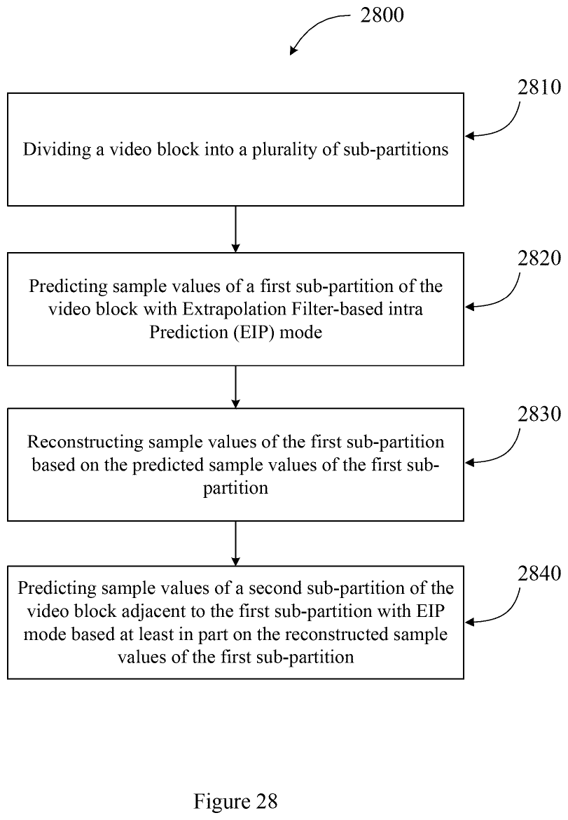

FIG. 28 illustrates a workflow of a method 2800 for video decoding according to one or more aspects of the present disclosure.

At step 2810, the method 2800 comprises dividing a video block into a plurality of sub-partitions.

At step 2820, the method 2800 comprises predicting sample values of a first sub-partition of the video block with Extrapolation Filter-based intra Prediction (EIP) mode.

At step 2830, the method 2800 comprises reconstructing sample values of the first sub-partition based on the predicted sample values of the first sub-partition.

At step 2840, the method 2800 comprises predicting sample values of a second sub-partition of the video block adjacent to the first sub-partition with EIP mode based at least in part on the reconstructed sample values of the first sub-partition.

In one example, the dividing the video block into a plurality of sub-partitions comprises: dividing the video block into 2 or 4 sub-partitions vertically or horizontally based on the size of the video block.

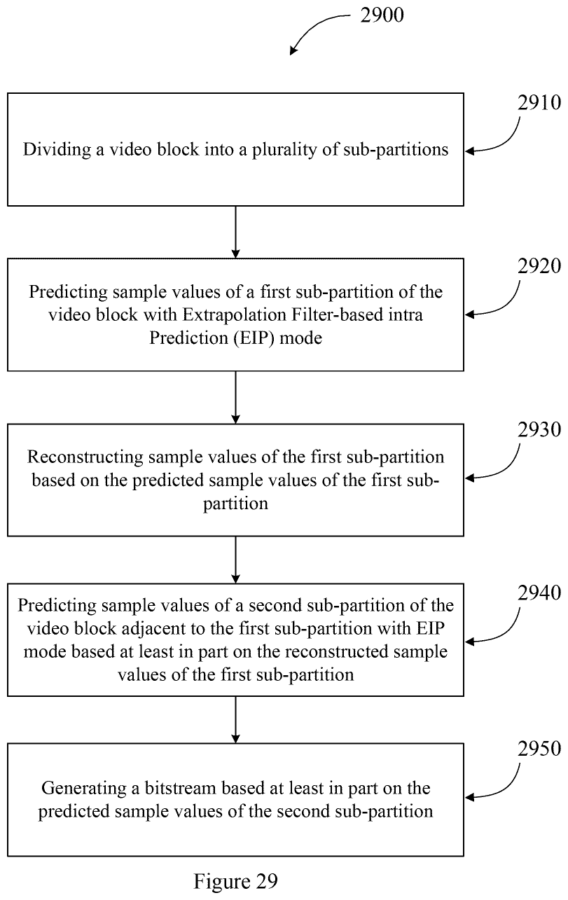

FIG. 29 illustrates a workflow of a method 2900 for video encoding according to one or more aspects of the present disclosure.

At step 2910, the method 2900 comprises dividing a video block into a plurality of sub-partitions.

At step 2920, the method 2900 comprises predicting sample values of a first sub-partition of the video block with Extrapolation Filter-based intra Prediction (EIP) mode.

At step 2930, the method 2900 comprises reconstructing sample values of the first sub-partition based on the predicted sample values of the first sub-partition.

At step 2940, the method 2900 comprises predicting sample values of a second sub-partition of the video block adjacent to the first sub-partition with EIP mode based at least in part on the reconstructed sample values of the first sub-partition.

At step 2950, the method 2900 comprises generating a bitstream based at least in part on the predicted sample values of the second sub-partition.

In one example, the dividing the video block into a plurality of sub-partitions comprises: dividing the video block into 2 or 4 sub-partitions vertically or horizontally based on the size of the video block.

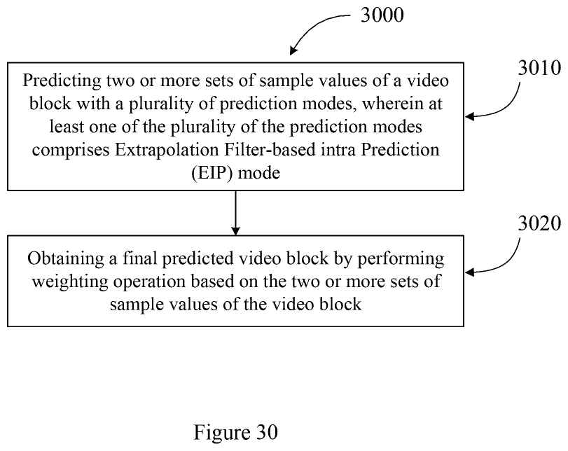

FIG. 30 illustrates a workflow of a method 3000 for video decoding according to one or more aspects of the present disclosure.

At step 3010, the method 3000 comprises predicting two or more sets of sample values of a video block with a plurality of prediction modes, wherein at least one of the plurality of the prediction modes comprises Extrapolation Filter-based intra Prediction (EIP) mode.

At step 3020, the method 3000 comprises obtaining a final predicted video block by performing weighting operation based on the two or more sets of sample values of the video block.

In one example, the plurality of prediction modes comprise at least one of: two EIP modes with different filter shapes and/or different templates; an EIP mode with filter coefficients determined based on previously decoded video block; planar mode; Intra Block Copy (IBC) mode; top predefine mode; or left predefine mode.

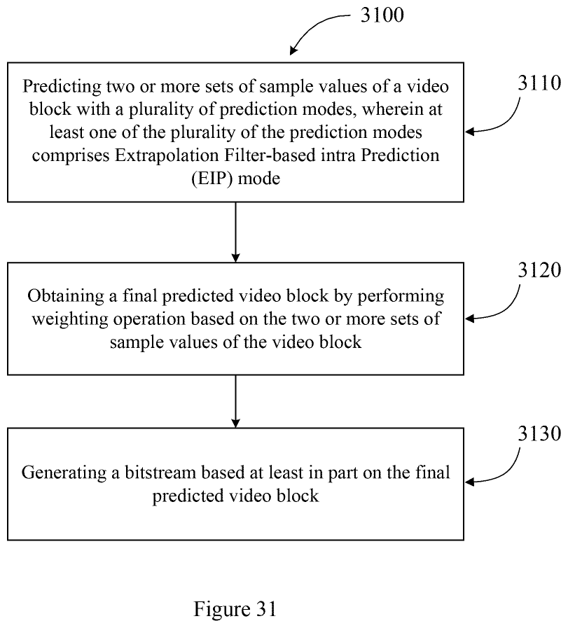

FIG. 31 illustrates a workflow of a method 3100 for video encoding according to one or more aspects of the present disclosure.

At step 3110, the method 3100 comprises predicting two or more sets of sample values of a video block with a plurality of prediction modes, wherein at least one of the plurality of the prediction modes comprises Extrapolation Filter-based intra Prediction (EIP) mode.

At step 3120, the method 3100 comprises obtaining a final predicted video block by performing weighting operation based on the two or more sets of sample values of the video block.

At step 3130, the method 3100 comprises generating a bitstream based at least in part on the final predicted video block.

In one example, the plurality of prediction modes comprise at least one of: two EIP modes with different filter shapes and/or different templates; an EIP mode with filter coefficients determined based on previously decoded video block; planar mode; Intra Block Copy (IBC) mode; top predefine mode; or left predefine mode.

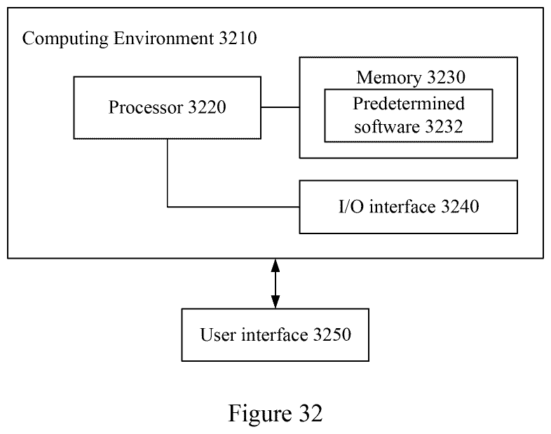

FIG. 32 shows a computing environment 3210 coupled with a user interface 3250. The computing environment 3210 can be part of a data processing server. The computing environment 3210 includes a processor 3220, a memory 3230, and an Input/Output (I/O) interface 3240.

The processor 3220 typically controls overall operations of the computing environment 3210, such as the operations associated with display, data acquisition, data communications, and image processing. The processor 3220 may include one or more processors to execute instructions to perform all or some of the steps in the above-described methods. Moreover, the processor 3220 may include one or more modules that facilitate the interaction between the processor 3220 and other components. The processor may be a Central Processing Unit (CPU), a microprocessor, a single chip machine, a Graphical Processing Unit (GPU), or the like.

The memory 3230 is configured to store various types of data to support the operation of the computing environment 3210. The memory 3230 may include predetermined software 3232. Examples of such data includes instructions for any applications or methods operated on the computing environment 3210, video datasets, image data, etc. The memory 3230 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 3240 provides an interface between the processor 3220 and peripheral interface modules, such as a keyboard, a click wheel, buttons, and the like. The buttons may include but are not limited to, a home button, a start scan button, and a stop scan button. The I/O interface 3240 can be coupled with an encoder and decoder.

In an embodiment, there is also provided a non-transitory computer-readable storage medium comprising a plurality of programs, for example, in the memory 3230, executable by the processor 3220 in the computing environment 3210, for performing the above-described methods and/or storing a bitstream generated by the encoding method described above or a bitstream to be decoded by the decoding method described above. In one example, the plurality of programs may be executed by the processor 3220 in the computing environment 3210 to receive (for example, from the video encoder 20 in FIG. 2) a bitstream or data stream including encoded video information (for example, video blocks representing encoded video frames, and/or associated one or more syntax elements, etc.), and may also be executed by the processor 3220 in the computing environment 3210 to perform the decoding method described above according to the received bitstream or data stream. In another example, the plurality of programs may be executed by the processor 3220 in the computing environment 3210 to perform the encoding method described above to encode video information (for example, video blocks representing video frames, and/or associated one or more syntax elements, etc.) into a bitstream or data stream, and may also be executed by the processor 3220 in the computing environment 3210 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 3220); and the non-transitory computer-readable storage medium or the memory 3230 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 3230, executable by the processor 3220 in the computing environment 3210, for performing the above-described methods. For example, the computer program product may include the non-transitory computer-readable storage medium.

In an embodiment, the computing environment 3210 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for video decoding, comprising:
determining a decoded video block predicted with Extrapolation Filter-based intra Prediction (EIP) mode;
obtaining a stored filter shape and stored filter coefficients corresponding to an extrapolation filter of the decoded video block; and
predicting sample values of a current block with EIP mode based on the stored filter shape and the stored filter coefficients.

2. The method of claim 1, further comprising:
determining that the current block is to be predicted with EIP mode in response to determining the decoded video block was predicted with EIP mode.

3. The method of claim 1, wherein the determining the decoded video block comprises:
obtaining a history-based EIP table comprising a set of video blocks predicted with EIP mode; and
selecting one of the set of video blocks as the decoded video block based on an index value received in a bitstream.

4. The method of claim 1, wherein precision of the stored filter coefficients for predicting the sample values of the current block is reduced compared with the precision of derived filter coefficients used for predicting the sample values of the decoded video block.

5. The method of claim 1, further comprising:
dividing a video block into a plurality of sub-partitions;
predicting sample values of a first sub-partition of the video block with Extrapolation Filter-based intra Prediction (EIP) mode;
reconstructing sample values of the first sub-partition based on the predicted sample values of the first sub-partition; and
predicting sample values of a second sub-partition of the video block adjacent to the first sub-partition with EIP mode based at least in part on the reconstructed sample values of the first sub-partition.

6. The method of claim 5, wherein the dividing the video block into a plurality of sub-partitions comprises:
dividing the video block into 2 or 4 sub-partitions vertically or horizontally based on a size of the video block.

7. The method of claim 1, further comprising:
predicting two or more sets of sample values of a video block with a plurality of prediction modes, wherein at least one of the plurality of the prediction modes comprises Extrapolation Filter-based intra Prediction (EIP) mode; and
obtaining a final predicted video block by performing weighting operation based on the two or more sets of sample values of the video block.

8. The method of claim 7, wherein the plurality of prediction modes comprise at least one of:
two EIP modes with different filter shapes and/or different templates;
an EIP mode with filter coefficients determined based on previously decoded video block;
planar mode;
Intra Block Copy (IBC) mode;
top predefine mode; or
left predefine mode.

9. A method for video encoding, comprising:
determining an encoded video block predicted with Extrapolation Filter-based intra Prediction (EIP) mode;
obtaining a stored filter shape and stored filter coefficients corresponding to an extrapolation filter of the encoded video block; and
predicting sample values of a current block with EIP mode based on the stored filter shape and the stored filter coefficients; and
generating a bitstream based at least in part on the predicted sample values of the current block.

10. The method of claim 9, further comprising:
determining that the current block is to be predicted with EIP mode in response to determining the encoded video block was predicted with EIP mode.

11. The method of claim 9, wherein the determining the encoded video block comprises:
obtaining a history-based EIP table comprising a set of video blocks predicted with EIP mode; and
determining one of the set of video blocks as the encoded video block to be signaled by an index value in a bitstream.

12. The method of claim 9, wherein precision of the stored filter coefficients for predicting the sample values of the current block is reduced compared with the precision of derived filter coefficients used for predicting the sample values of the encoded video block.

13. The method of claim 9, further comprising:
dividing a video block into a plurality of sub-partitions;
predicting sample values of a first sub-partition of the video block with Extrapolation Filter-based intra Prediction (EIP) mode;
reconstructing sample values of the first sub-partition based on the predicted sample values of the first sub-partition;
predicting sample values of a second sub-partition of the video block adjacent to the first sub-partition with EIP mode based at least in part on the reconstructed sample values of the first sub-partition; and
generating a bitstream based at least in part on the predicted sample values of the second sub-partition.

14. The method of claim 13, wherein the dividing the video block into a plurality of sub-partitions comprises:
dividing the video block into 2 or 4 sub-partitions vertically or horizontally based on a size of the video block.

15. The method of claim 9, further comprising:
predicting two or more sets of sample values of a video block with a plurality of prediction modes, wherein at least one of the plurality of the prediction modes comprises Extrapolation Filter-based intra Prediction (EIP) mode;
obtaining a final predicted video block by performing weighting operation based on the two or more sets of sample values of the video block; and
generating a bitstream based at least in part on the final predicted video block.

16. The method of claim 15, wherein the plurality of prediction modes comprise at least one of:
two EIP modes with different filter shapes and/or different templates;
an EIP mode with filter coefficients determined based on previously decoded video block;
planar mode;
Intra Block Copy (IBC) mode;
top predefine mode; or
left predefine mode.

17. An apparatus, comprising:
one or more processors; and
one or more storage devices storing instructions that, when executed by the one or more processors to perform operations of the method according to claim 1.

18. An apparatus, comprising:
one or more processors; and
one or more storage devices storing instructions that, when executed by the one or more processors, cause the apparatus to perform operations of the method according to claim 9.

19. A non-transitory computer readable storage medium storing a bitstream formed by instructions which when executed by a computing device having one or more processors, cause the one or more processors to perform the encoding method according to claim 9.

20. A method for transmitting a bitstream, comprising:
performing the encoding method according to claim 9 to generate a bitstream; and
transmitting the bitstream.
